(19) United States
(12) Patent Application Publication
(10) Pub. No.: US 2023/0245080 A1
(43) Pub. Date: Aug. 3, 2023

(54) Convergent Consensus Method for Distributed Ledger Transaction Processing

(71) Applicant: Michael ANDERSON, Pasadena (SG)

(72) Inventor: Michael ANDERSON, Pasadena (SG)

(21) Appl. No.: 18/000,323

(22) PCT Filed: Jun. 4, 2021
(86) PCT No.: PCT/EP2021/065080

§ 371 Date: Nov. 30, 2022

(30) Foreign Application Priority Data
Jun. 4, 2020 (GB) 2008452.1
Aug. 17, 2020 (GB) 2012819.5

(51) Int. Cl. G06Q 20/06; G06Q 20/38; G06Q 20/40; H04L 9/32

(52) U.S. Cl. CPC G06Q 20/06; G06Q 20/3825; G06Q 20/3827; G06Q 20/4014; H04L 9/3247; H04L 9/3297; G06Q 2220/00

(57) ABSTRACT

A computer system and computer-implemented method for efficiently achieving convergent consensus in a distributed network of nodes that maintains a decentralised database or ledger with immutable data storage. Via transactions, client nodes request updates to the ledger that are verified by a set of peer nodes to achieve a new agreed consensus across the whole network. The process involves a Belief Merge Function and a State Transition Function that rapidly converge to consensus. The convergence method uses peers' “proof of stake” to avoid the high cost of “proof of work” alternatives that have unsustainable energy requirements. Embodiments of the system have a capacity for tens of thousands of transactions per second.

### FIELD OF THE INVENTION

The present invention relates to the systems and methods in distributed ledger technology (DLT). Consensus in such environments relates to the digital, cryptographically protected, systems and processes that provide distributed agreement and immutable evidence for the update of information or secure transfer of value between contracting parties. Consensus on DLT transactions is typically maintained by many peers in an Internet connected network.

### BACKGROUND OF THE INVENTION

Distributed ledger technology (DLT) is decentralised database and computation technology, (some types of which are terms called Blockchain technology), frequently operating on the Internet. DLT is often characterised by decentralisation, transparency, tamperproof, trustworthiness, collective maintenance, and traceability. Blockchains are used extensively in the financial industry and usage is continuing to grow in other sectors e.g. supply chains requiring transfer of digital tokens representing value.

Data in blockchains is distributed over a network of servers, sometimes known as nodes (or Peers in the context of this Invention), connected via communication protocols. Blockchain nodes typically participate in a shared process to achieve consensus which ensures that they all agree on the same data values.

Many current DLT systems require a lot of computer processing power and/or data storage, which in turn wastes a lot of energy and hardware resources. This consequently results in high costs incurred for every single business transaction. This low efficiency means they are often not viable for small transactions typical for payments or consumer applications. There are often long delays before consensus is achieved. For example, Bitcoin transactions may require more than 10 minutes to confirm and cost many US dollars owing to enormous energy consumption. Ethereum, another major blockchain, has latency of approximately 20 seconds, with a maximum global throughput of 15 to 20 transactions per second.

Other consensus approaches have attempted to avoid these problems by limiting the set of participants. This implies centralised control by a single entity or a small number of trusted entities. Examples are “Proof of Authority” networks such as Ripple or Hyperledger. Such approaches cannot provide consensus for open decentralised networks, where any Peer (including untrusted and potentially malicious participants) can participate freely in consensus without any centralised controls.

Some blockchains are also vulnerable to attacks on their security and integrity, e.g. Bitcoin is known to be vulnerable to a “51%” attack where malicious attackers can rewrite some recent blockchain history and potentially profit from disrupting the consensus order of transactions.

Operators of DLT nodes often need to be compensated for their processing and data storage costs with a financial incentive. There is therefore a need to ensure that the incentives for node operation are well aligned with the requirements for trustworthy node operation. Many networks use a notion of “mining” to reward node operators (Proof of Work). More recent innovations have suggested ideas of node operators being rewarded on the basis of some economic stake that they invest in the network (Proof of Stake).

The present Invention presents a significant advance in the state of the art for DLT, addressing many of the performance, scalability and cost issues of previous approaches while maintaining high security even in a fully decentralised environment.

### SUMMARY OF THE INVENTION

A first aspect of the invention provides a system for achieving efficient Consensus comprising: one or more nodes of various types arranged as arbitrary communication and functional participants in a Network, wherein at least a first node type is termed a Peer, means for the production of Beliefs by Peers such that each Belief contains data used for forming Consensus; a Belief Merge Function which combines one or more Beliefs; wherein the Peers are arranged to maintain the Consensus of the network according to a Consensus Protocol including the application of the Belief Merge Function to Beliefs; wherein the Belief Merge Function is defined such that the Network is exhibits the property of Convergence to a single Consensus.

Preferably, at least a second node type is termed a Client; and wherein the Clients are arranged to submit new Transactions that may affect the Consensus and query information resulting from the Consensus of the Network.

Preferably, the Belief Merge Function is defined using a computation that is idempotent, associative and commutative, such that the system is able to operate as a Conflict-free Replicated Data Type.

Preferably, the system may further comprise:

a specific type of information units, known as Blocks; full or partial Orderings of the specific type information units, Blocks, comprising Values and Cells, included as a constituent part of a Belief; a State Transition Function capable of computing an updated State given some Ordering; one or more Initial States; wherein a Consensus State may be computed by repeated application of the State Transition Function to an Initial State and information unit(s) that may be included in the Ordering.

Preferably, the system may further comprise:

collections of zero or more information units known as Transactions which are included as constituent parts of each Block; optional additional information supplied by the Peer, such as a timestamp or digital signatures; wherein the Blocks and their constituent Transactions and any additional information are arranged to be included as part of the Ordering.

Preferably, the information units in an Ordering are defined not to contain references to one or more previous information units, such that it is possible to re-order the Blocks in the Consensus process.

Preferably, the system may further comprise:

means for Computation of Consensus Orderings; wherein the means for Computation of Consensus Ordering computes an Consensus Ordering as part of the Belief Merge Function.

Preferably, the system may further comprise:

means for assigning a Stake to Peers; a procedure for Stake Weighted Ordering Merge included as part of the Computation of Consensus Ordering; wherein the Stake Weighted Ordering Merge is utilised to resolve conflicts between Orderings proposed by different Peers.

Preferably, the system may further comprise:

means for Common Prefix Computation; wherein the computation of a Common Prefix between Orderings is utilised to reduce the computational costs for Consensus.

Preferably, the system may further comprise:

means for Novelty detection; wherein nodes observing Novelty may communicate Novelty to other nodes; wherein nodes may optionally omit communication of information that is not Novelty, in order to save network resources and processing costs.

Preferably, the system may further comprise:

means for representing information Values, which are represented as one or more Cells;
means for producing an Encoding for a Cell, preferably in a form suitable for storage or Network communication; means for Smart References enabling a reference to a Cell to be included within the information and/or Encoding of another Cell; means for embedding an Encoding within another Encoding thereby enabling any Value to be completely represented as a graph of Cells connected by Smart References.

Preferably, the system may further comprise:

means for producing a Value ID for a Cell, such as a cryptographic hash function applied to the Encoding; wherein the Value ID can be used as a unique reference for the information unit.

Preferably, the system may further comprise:

a Convergent Storage for information values; wherein only the information units currently in active use are required to be in the working memory of a node, and other information units can be persisted to permanent storage and/or deleted if not required for further processing, i.e., garbage collected; wherein the addition of new information to Storage has the Convergence property, such that data inconsistencies may be avoided.

Preferably, the system may further comprise:

means for computing the Memory Size of a Cell or other information Value; means for Memory Accounting; wherein the Memory Accounting is used to assign Incentives to participants on the network, such as to conserve memory, storage and/or communication bandwidth.

Preferably, the system may further comprise:

means of caching computed Memory Sizes for each Cell or information unit either in working memory and/or Storage; wherein cached Memory Sizes are used to reduce the computational complexity of computing the memory size for large data structures, such as only needing to compute the Memory Size for Novelty.

Preferably, the system may further comprise:

means for Trusted Code Execution arranged to be part of the State Transition Function; wherein the Trusted Code Execution can be utilised to implement Smart Contracts or other programmable functionality that may affect the Consensus State.

Preferably, the system may further comprise:

one or more Monotonic Headers, which associate header information with information Values and/or Cells; wherein the Monotonic Header also provides the property of Convergence, such that is can be relied upon for caching, performance optimisation and tagging the status of Cells.

A second aspect of the invention provides a computer-implemented method for achieving efficient Consensus comprising:

arranging one or more nodes of various types as arbitrary communication and functional participants in a Network, wherein at least a first node type is termed a Peer, generating Beliefs by Peers such that each Belief contains data used for forming Consensus; combining one or more Beliefs into a Belief Merge Function; wherein the Peers are arranged to maintain the Consensus of the network according to a Consensus Protocol including the application of the Belief Merge Function to Beliefs; wherein the Belief Merge Function is defined such that the Network is exhibits the property of Convergence to a single Consensus.

Preferably, the Belief Merge Function is defined using a computation that is idempotent, associative and commutative, such that the system is able to operate as a Conflict-free Replicated Data Type.

Preferably, the method may further comprise:

a specific type of information units, known as Blocks; full or partial Orderings of the specific type information units, Blocks, comprising Values and Cells, included as a constituent part of a Belief; a State Transition Function capable of computing an updated State given some Ordering; one or more Initial States; wherein a Consensus State may be computed by repeated application of the State Transition Function to an Initial State and information unit(s) that may be included in the Ordering.

Preferably, the method may further comprise:

computing Consensus Orderings; wherein the Consensus Ordering is computed as part of the Belief Merge Function.

Preferably, the method may further comprise:

assigning a Stake to Peers; a procedure for Stake Weighted Ordering Merge included as part of the Computation of Consensus Ordering; wherein the Stake Weighted Ordering Merge is utilised to resolve conflicts between Orderings proposed by different Peers.

Preferably, the method may further comprise:

computing Common Prefix; wherein the computation of a Common Prefix between Orderings is utilised to reduce the computational costs for Consensus.

Preferably, the method may further comprise:

detecting Novelty; wherein nodes observing Novelty may communicate Novelty to other nodes; wherein nodes may optionally omit communication of information that is not Novelty, in order to save network resources and processing costs.

Preferably, the method may further comprise:

representing information Values, which are represented as one or more Cells; producing an Encoding for a Cell, preferably in a form suitable for storage or Network communication; enabling Smart References a reference to a Cell to be included within the information and/or Encoding of another Cell; embedding an Encoding within another Encoding thereby enabling any Value to be completely represented as a graph of Cells connected by Smart References.

Preferably, the method may further comprise:

producing a Value ID for a Cell, such as a cryptographic hash function applied to the Encoding; wherein the Value ID can be used as a unique reference for the information unit.

Preferably, the method may further comprise:

computing the Memory Size of a Cell or other information Value; accounting Memory; wherein the Memory Accounting is used to assign Incentives to participants on the network, such as to conserve memory, storage and/or communication bandwidth.

Preferably, the method may further comprise:

caching computed Memory Sizes for each Cell or information unit either in working memory and/or Storage; wherein cached Memory Sizes are used to reduce the computational complexity of computing the memory size for large data structures, such as only needing to compute the Memory Size for Novelty.

Preferably, the method may further comprise:

arranging Trusted Code Execution to be part of the State Transition Function; wherein the Trusted Code Execution can be utilised to implement Smart Contracts or other programmable functionality that may affect the Consensus State.

### BRIEF DESCRIPTION OF THE DRAWINGS

The drawings are illustrative to aid understanding of the invention and/or the embodiment that follows the description of the invention.

FIG. 1 depicts an example Network of Peers and Clients that participate in a Consensus method in accordance with the invention;

FIG. 2 illustrates an example process for merging different Beliefs from several Peers to create a single Belief that is shared by all Peers;

FIG. 3 shows how Consensus States might be updated using a Consensus Ordering of blocks as a result of applying a State Transition Function;

FIG. 4 shows examples Peers to be included in a Voting Set based on their Orderings;

FIG. 5 shows the results of the Stake voting process that creates the Winning Ordering from the perspective of a Peer;

FIG. 6 shows the difference between tightly coupled traditional blockchains compared with the Consensus method of this invention which produces loosely coupled Orderings;

FIG. 7 shows a process for allocating rewards via pools of Incentive funds;

FIG. 8 illustrates a process for distributing transaction fees for a single transaction;

FIG. 9 shows changes to an Ordering for a single Peer as part of a Belief merge.

### DESCRIPTION OF THE INVENTION

The present invention relates to the systems and methods in distributed ledger technology (DLT). Consensus in such environments relates to the digital, cryptographically protected, systems and processes that provide distributed agreement and immutable evidence for the update of information or secure transfer of value between contracting parties. Consensus on DLT transactions is typically maintained by many Peers in an Internet connected network. The present Invention presents a significant advance in the state of the art for DLT, addressing many of the performance, scalability and cost issues of previous approaches while maintaining high security even in a fully decentralised environment.

### Description Overview

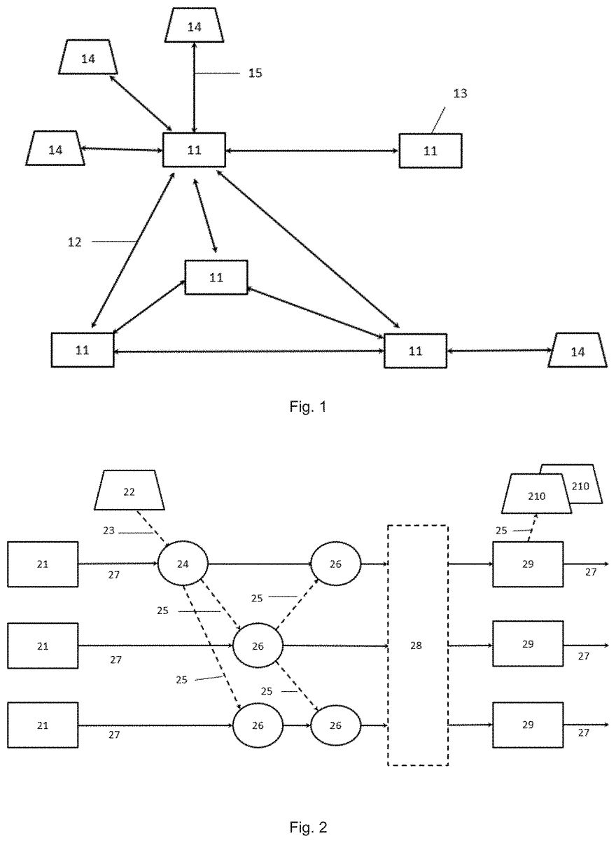

Referring to FIG. 1, there is presented an example of a Network of Peers and Clients that participate in a Consensus method in accordance with the invention, which is an overview of the Network.

Peers operate independent nodes in a Network with a method to agree Consensus over information of interest to network participants (typically termed Consensus State). Clients are typically interested in observing or making changes to the Consensus through Transactions. Embodiments may support applications such as:
Operation of cryptocurrency or tokenized applications;
Execution of “Smart Contracts”;
Establishing verifiable public provenance;
Operation of decentralised applications such as financial services;
Publishing digital intellectual property and receiving micro-payments;
Managing non-fungible tokens for gaming, auctions and digital assets;
Providing a trustworthy public database for identity verification and a public key infrastructure;
Providing escrow or collateral services for complex financial transactions.

Objectives of embodiments of the invention include, but are not limited to:
Trustless Consensus, achieved even in the presence of malicious actors seeking to invalidate Consensus or steal resources from other participants.
Low latency, reaching global Consensus in approximately 1 second;
High throughput, reaching to tens of thousands of Transactions per second;
Guaranteed Ordering of Transactions, including prevention of “double spend” attacks;
General purpose computation, enabling arbitrary “smart contracts” as part of the on-chain protocol;
Efficient processing and memory usage, scaling with the number of Transactions, not the size of data blocks representing the on-chain State.

Embodiments using the Consensus method, may only need to process that part of the State that is currently in use and needed in fast access memory. Working memory requirement is proportional to the work done, bounded by the Transaction size. Furthermore, due to convergent immutable storage or structural sharing, only deltas (changes) may be needed to share with Peers.

The Consensus method operates on a decentralised network of Peers that agree on consistent, replicable states confirming Transaction completion. It ensures that all participants agree on a single version of the truth using Stake weighted voting. Every decentralised economic system needs to enforce ownership of digital assets. It may use “Delegated Proof of Stake” to avoid wasting resources and energy experienced with “Proof of Work” methods. Embodiments using the on-chain Consensus method are environmentally friendly by incorporating a variant of “Conflict-free Replicated Data Type” (CRDT), which converges to Consensus after a few rounds of random gossip between Peers.

The Consensus method operates a defined protocol (“the Consensus Protocol”) on one or more distributed Peers operating as a Network. Consensus is achieved after Peers agree the validity of a set of data information and the Transactions related to the generation of that data. During processing, virtual States are derived which represent a configuration of information managed by the Network. Resources, such as cryptocurrency Accounts, Smart Contracts or arbitrary data, are controlled via cryptographic mechanisms to prevent unauthorized access or modification. Transactions may be applied to update States, such as transferring funds from one Account to another, modifying data or invoking computations such as Smart Contracts.

System and method for achieving consensus on the ordering of information units in an on-chain distributed ledger domain and off-chain client portal as a better alternative to the understood concepts of Blockchain methodologies, comprising multiple nodes of various types arranged as arbitrary communication and functional participants in the network; a first node type, a peer, is arranged to maintain the consensus of the network; a second node type, a client, is arranged to query the consensus of the network; and wherein the calculation of consensus by each peer is governed by a Belief Merge Function that merges Beliefs shared by peers to create updated beliefs.

The invention discloses system and method for achieving efficient consensus in a distributed computing environment comprising:
multiple nodes of various types arranged as arbitrary communication and functional participants in the network, where a first node type is termed a Peer, and
an optional second node type is termed a Client;
wherein the Peers are arranged to maintain the consensus of the network;
wherein the Clients are arranged to query information resulting from the consensus of the network and also submit new information that may affect the consensus.

The Peers produce information units (termed Beliefs) wherein each Belief contains information relevant to consensus that is known by the given Peer.

The calculation of consensus by each peer is governed by a Belief Merge Function that merges Beliefs shared by peers to create updated Beliefs where the Belief Merge Function satisfies mathematical properties (preferably a computation that is idempotent, associative and commutative) that guarantee convergence to a consensus value (under certain assumptions), even allowing for the presence of some malicious peers.

The Belief incorporates information sourced from multiple peers, which may be signed with digital signatures to prove authenticity and integrity.

The second node type, (the Client), is arranged to submit Transactions (potentially including novel information) to be included in consensus to the first node type (the Peers).

Additional node types, which may have additional roles in addition to Clients and Peers, and may combine the functionality of Clients and Peers.

The computation of consensus values includes a full or partial Ordering of some information units, where these units are independent of each other (e.g. do not need to contain a reference to the previous information unit), such that they may be ordered differently according to the progress of the consensus algorithm.

The information units are Blocks, which are proposed by Peers and may comprise:
A collection of zero or more individual Transactions that have been collected from Clients
Additional information supplied by the Peer, such as a timestamp or digital signature.
Any other information that may affect the consensus computation of the network.

The blocks do not contain references to one or more previous block(s), such that it is possible to re-order the blocks in the consensus process.

The ordered information units are used to compute a State by the repeated application of a State Transition Function, such that each Peer can independently and reliably compute the exact same State given an Ordering that has been determined by the Consensus system and any other relevant information included in the consensus computation.

The Belief Merge Function computes an (actual or proposed) consensus according to votes received from other Peers in their respective Beliefs, where each vote represents a Peer's preference for the next information unit(s) to be included in the ordering.

The voting for each information unit in the Ordering is resolved sequentially, and those peers voting for the “winning” information unit are given greater weight (or exclusively permitted) to have their vote counted for subsequent information units (a procedure referred to as Stake Weighted Ordering Merge).

The computation of a common prefix between orderings proposed by different Peers can be used to efficiently determine the extent to which peers are in agreement regarding their respective orderings.

The first node type, the Peer, is arranged to possess an economic stake (which may be zero) which determines the weight the voting weight of peers is adjusted by the amount of economic stake placed on the consensus, which may be placed by either the owner of the peer, or delegated stake by other participants, or a combination of both.

The system increases bandwidth efficiency and manages memory consumption by scaling resource requirements in a manner that is bounded proportionately to the number of new transactions (as opposed to the size of total on-chain state).

The system shares among nodes only the changes/novelty observed, (e.g. new transactions representing previously unseen novelty), plus any structural or accounting overhead, and may omit information that has already been communicated.

The system of any of the preceding claims, wherein the information units are defined to have a canonical Encoding in a low level information format (e.g. a sequence of bytes).

The Encodings may be passed through a cryptographic hash function to produce a unique Value ID for each distinct information unit value, such that the Value ID can be used as a reference to the information unit itself.

The Value ID may be embedded as a reference in the Encoding of other information units, such that these references form a Merkle DAG (Directed Acyclic Graph).

Only the information units currently in active use are required to be in the working memory of a node, and other information units can be persisted to permanent storage and/or garbage collected (which may be automatic, e.g. as provided by the Java Virtual Machine).

Any information unit in memory or storage may be associated with header information which may be incrementally computed or cached, may be constructed so that changes to the header are monotonic with respect to values in the header.

A function is provided to calculate a value representing the Memory Size of an information unit, which may for example comprise the size of the Encoding plus an allowance for storage overheads.

The memory size calculation may be increased depending on the Memory Size of any referenced information units, such that the total Memory Size represents the size of the entire Merkle DAG.

The Memory Size is cached alongside information units (in node working memory and/or storage), such that the Memory Size can often be computed efficiently without traversing the entire Merkle DAG.

The Memory Size is used in a system of Memory Accounting and may be utilised to create economic incentives, for example charging fees for processing of transactions with a large memory size or increasing the size of the overall State in the State Transition Function.

The economic incentive includes a reward for reducing Memory Size, such that participants may have an incentive to utilise the resources of the system more efficiently.

### Performance, Efficiency and Utility

The invention is designed to improve transaction throughput and latency, especially compared to inefficient “Proof of Work” consensus methods, which depend on forcing nodes to undertake computationally expensive tasks (which typically add no value to the network other than enhancing security).

The invention preferably achieves low latency by avoiding any requirement for wasteful work, having an efficient Encoding of Values well suited for efficient Storage and communication. It, employs data structures and algorithms well-suited to efficient performance (such as structural sharing within immutable Values, Merkle trees, and Common Prefix Computation)

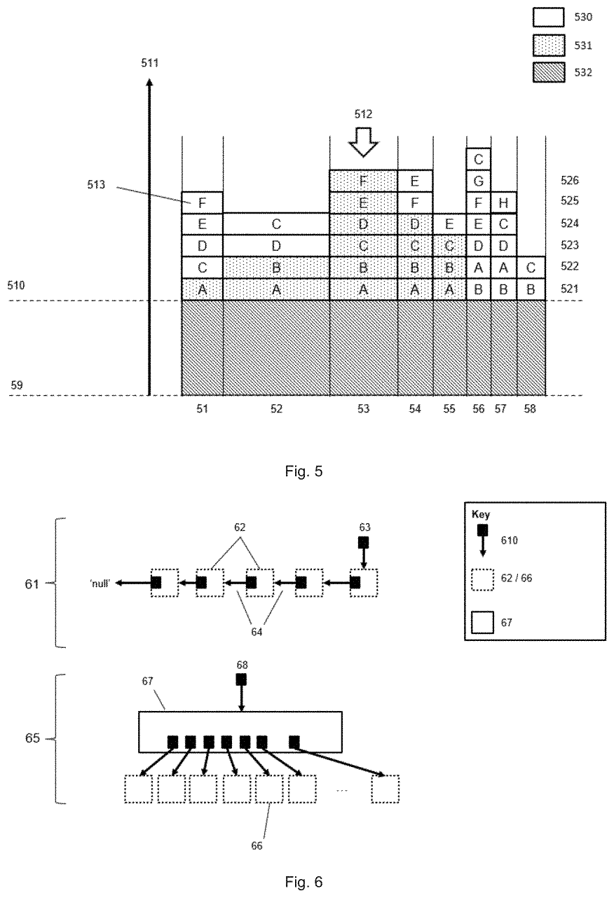

Embodiments preferably improve both latency and transaction throughput by allowing Peers to concurrently propose Orderings of Blocks in a loosely coupled manner (See FIG. 6), which avoids the need to sequentially append Blocks in a tightly coupled Blockchain.

Embodiments preferably improve latency further by implementing a staged event-driven architecture (sometimes referred to as SEDA in the field) which facilitates immediate, asynchronous handling of messages as soon as nodes or components in a node are able to process them.

### Security Considerations

It is often the case that some participants in the Network are not trusted, for example they may attempt to disrupt or manipulate the Consensus in an unauthorized manner. These untrusted actors are sometimes known as “Byzantine” or “Sybil” actors. Embodiments of a network preferably achieve “Byzantine Fault Tolerance” that is robust to unauthorised updates, intentional or otherwise, from multiple bad actors.

The Consensus is preferably designed to be stable once established. Actors may need to rely on an assurance that Transactions have been completed, such as a transfer of cryptocurrency or tokens. Without this guarantee, Actors may be at significant economic risk if Transactions are subsequently cancelled or rolled back.

Preferably, embodiments make use of strong digital signature approaches (such as Ed25519) so that they can verify the authenticity of information shared on the Network.

### DESCRIPTION OF THE INVENTION IN CONJUNCTION WITH THE FIGURES

Referring to FIG. 1, there is shown an example Network of Peers and Clients that participate in a Consensus method in accordance with the invention.

In FIG. 1 the reference numerals refer to:
11—A set of Peers participating in the consensus system.
12—Connection between Peers, which may be opened and closed at various times and enable communication of information when open. It is not necessary for every Peer to be connected to every other Peer at all times.
13—A Peer that is connected only to one other Peer, but indirectly is still connected to the entire network.
14—A set of Clients, which connect to Peers and use this connection to submit new transactions to the network or make queries.
15—Connection between Clients and Peers.

More specifically, a Set of Peers [11] are connected to each other [12] either directly or indirectly [13]. A set of Clients [14] make connections [15] for the purpose of participating in the Network.

FIG. 2 illustrates an example process for merging different Beliefs from several Peers to create a single Belief that is shared by all Peers.

In FIG. 2 the reference numerals refer to:
21—A set of Peers participating in the consensus system, each possessing an initial Belief
22—A client (which also may be a Peer) generates Novelty in the form of 21 or more transactions.
23—Novelty is communicated by the Client to at least one Peer (this step may be omitted if the Client is itself also a Peer.
24—A process which incorporates the novelty by including it in the Belief of at least on Peer.
25—Transmission of an updated Belief from a Peer to other Peer(s) in the network.
26—A process which performs the function of a Belief Merge executed by a Peer, combining its own most recent Belief with the Beliefs received from other Peer(s) in order to produce an updated Belief
27—Maintenance of data by single participant, showing flow of time.
28—A period of time in which transmission and merge of updated Beliefs (as 25. and 26.) are iteratively repeated until the Novelty introduced by 22 is confirmed by a sufficient number or Peers to be part of the stable consensus.
29—Peers which are now in consensus with respect to the Novelty, and are able to compute an updated Consensus State with the State Transition Function.
210—Any Clients which are interested in the results of consensus (which may include the original Client) may observe the consensus results and receive confirmation that the Novelty has been successfully included.

More specifically, a Client [22] (which also may be a Peer) submits 1 or more Transactions [23], which may be considered Novelty. A set of Peers [21] participate in the consensus process, each possessing an initial Belief. A process [24] incorporates the Novelty by including it in the Belief of at least one Peer [21]. Transmission of Updated Beliefs [25] are transmitted from the first Peer to other Peers [21] in the network. Processes [26] perform the Belief Merge Function executed by each Peer, combining their own most recent Belief with the Beliefs received from other Peers to produce an updated Belief. Each Peer [21] maintains its own Belief data [27] over the time period during and after the merge process. Time period [28] represents the iterative transmission and merge of updated Beliefs [24, 25, 26] until the Novelty introduced by Client [22] is confirmed in Consensus by a sufficient number of Peers. After Consensus is reached, Peers [29] are now able to compute an updated Consensus State with the State Transition Function. Any Clients [210], which may include the original Client [22], may query [211] the consensus to confirm a successful Belief merge and access other information in the new Consensus State.

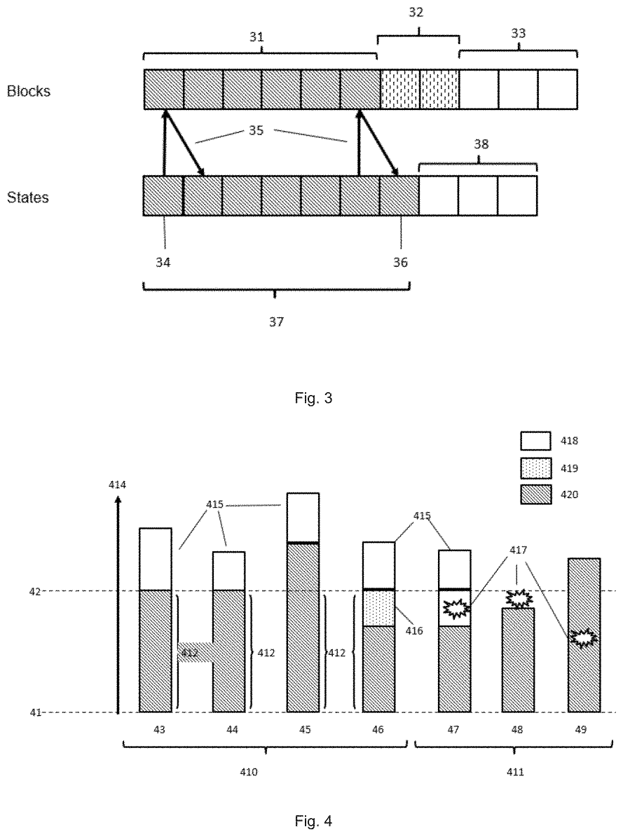

FIG. 3 shows how Consensus States might be updated using a Consensus Ordering of blocks as a result of applying a State Transition Function.

In FIG. 3 the reference numerals refer to:
31—A number of Blocks in an Ordering which are considered to be in current Consensus Ordering.
32—A collection of additional Blocks to be in the future Proposed Ordering (in addition to the Consensus Ordering).
33—Additional Blocks beyond the Proposed Consensus, which may contain new Blocks submitted either a Peer or Client.
34—The Initial State, used as input for the State Transition Function for the first Block
35—Application of the State Transition Function, which takes a State and a corresponding Block to compute the next State.
36—The Consensus State, e.g. the State after all Blocks in the Consensus Ordering have been processed by 35.
37—The sequence of States produced from the Initial State up to the Consensus State
38—Optional: prediction of future State updates based on possible future Consensus Orderings, which represent what States would result from application of the state transition function to Blocks in 32 and 33.
   More specifically, starting with an Initial State [34] a set of Blocks in the Consensus Ordering [31] are processed through a State Transition Function [35] in repeated steps until the Consensus State [36] is produced. Additional Blocks in the Ordering [32 and 33] could optionally be used to predict possible future Consensus States [38] although this is not yet confirmed in Consensus. [37] indicates the full Sequence of States computed up to and including the Consensus State.

FIG. 4 shows examples Peers to be included in a Voting Set based on their Orderings.

In FIG. 4 the reference numerals refer to:
41—The start of the Consensus Ordering under consideration (typically the first block in the Ordering).
42—The Consensus Point of the current Peer performing the belief merge, which defined the current Consensus from the perspective of this Peer.
43—The Ordering of the Current Peer.
44—The Ordering of a Peer that has the same Consensus as the current peer, although maybe different following Blocks.
45—The Ordering of some other Peer that has a Consensus Ordering longer than the current Peer, but is compatible at least up to the current Consensus [42].
46—The Ordering of some other Peer that has a Consensus Ordering shorter than of the current Peer, but is otherwise proposing an Ordering that is equal to the current Peer up to [42].
47—The Ordering of a Peer that has a Consensus Ordering shorter than of the current Peer, and has a following Ordering where one or more blocks are different from the Consensus up to the[42], and which must therefore be excluded.
48—The Ordering of a Peer which has insufficient blocks to compare with the current Consensus, and which therefore must be excluded.

49—The Ordering of a Peer that has declared a Consensus Ordering that is incompatible with the current Consensus, and which therefore must be excluded (and may also be subject to penalties).
410—The set of Peers which will be included in Voting Set, because they are compatible up to the Consensus Point [42].
411—The set of Peers which will be excluded from the Voting Set, because their orderings are not equal to the current Peer (up to the current Consensus Point [42]).
412—Subsets of Orderings which are observed to be matching the current Peer up to the Consensus Point [42].
414—Ordering length in number of Blocks.
415—Orderings of Blocks beyond [42], which are not relevant for consistency.
416—Blocks matching the Consensus Ordering of [43], in the Ordering of [46] but not yet in the Consensus Ordering of [46].
417—Positions where Blocks are inconsistent with the Consensus Ordering of [43].
418—Shading for Blocks not matching or beyond the position of [412].
419—Shading for Blocks matching [412] but not in a Consensus Ordering.
420—Shading for Blocks in the Consensus Ordering of the respective Peer.

Peers are included or excluded according to consistency with the Consensus Ordering of the current Peer [43]. The Current Peer considers the Consensus Ordering to be the Blocks between [41] and [42] in its own Ordering. Peers [44], [45] and [46] are all Consistent because their Orderings match the Consensus Ordering [412] of the current Peer as far as [42], beyond which point additional blocks in the Ordering [415] are never considered inconsistent. Peers [47], [48] and [49] are excluded for inconsistency [417] when compared to the Consensus Ordering of [43]. Peer [47] is excluded because it has one or more inconsistent Blocks in its Ordering [418]. Peer [48] is excluded because its entire Ordering is shorter than the point [42], and therefore cannot match. Peer [49] is excluded because some Block between [41] and [42] is inconsistent with [43]. [410] is the set of Peers which will be included in the Voting Set. [411] is the set of Peers which will be excluded from the Voting Set. [412] are the subsets of Orderings that match the Consensus Ordering of [43]. [414] Indicates Ordering length. [415] are additional Blocks not relevant to consistency. [416] are consistent Blocks not yet in Peer [46]'s Consensus Ordering. [417] are points of inconsistency. [418] indicates Blocks not matching or beyond the position of [412]. [420] indicates Blocks in the Consensus Ordering of the respective Peer.

FIG. 5 shows the results of the Stake voting process that creates the Winning Ordering from the perspective of a Peer.

In FIG. 5 the reference numerals refer to:
51—Current Peer.
52 to 58—Other Peers in initial Voting Set (column widths indicate proportionate voting weight).
59—Start of Orderings (First Block).
510—Current Consensus Point (of Peer 51).
511—Length of Orderings.
512—Winning Ordering after all voting rounds complete.
513—Symbols A to H denote different Blocks included in Orderings of various Peers.
521—Result of round: Block A Wins.
522—Result of round: Block B Wins (Among Peers who voted for A in 521).
523—Result of round: Block C Wins (Among Peers who voted for B in 522, Most voters for D already excluded).
524—Result of round: Block D Wins (Among those who voted for A, B, C previously).
525—Result of round: Block E Wins (Peer 53 outweighs Peer 54).
526—Result of round: Block F Wins (By default, only Peer 53 remains).
530—Shading for Blocks not part of the Winning Ordering.
531—Shading for Blocks part of the Winning Ordering in respective rounds.
532—Shading for Blocks already consistent with Consensus Ordering.

Peer [51] is the current Peer, which has the current Consensus Ordering from [59] to [510] and proposes five new Blocks designated with arbitrary symbols [A, C, D, E, F]. Each of the other Peers [52 to 58] also have orderings that match the Consensus Ordering up to [510] and their own proposals for future Blocks [A-H] in their Orderings, some of which may match the blocks proposed by other Peers. Together the Peers [51-58] comprise the “voting set” under consideration (see FIG. 4). Note that the proposed blocks are not in the same order for each Peer Ordering. Consensus is reached after six rounds of voting:
Round 521: Five Peers [51 to 55] vote that Block A should be the next in the Ordering and win the round
Round 522: Block B is voted winner by four Peers [52 to 55], out of those remaining from round 521;
Round 523: Block C is voted winner by three Peers [53, 54,55];
Round 524: Block D is voted winner by two Peers [53 and 54]
Round 525: Block E is voted winner by one Peer [53]
Round 525: Block F wins by default, since it is voted for by the only remaining Peer in the voting Set [53], thus resulting in the final Winning Ordering [512]

Shading: [530] indicates Blocks not part of the Winning Ordering, [531] indicates Blocks part of the Winning Ordering in respective rounds, [532] indicates Blocks already consistent with Consensus Ordering.

The width of Peer orderings [51-58] in the diagram indicates the voting weight, which is proportional to the Peer's Stake.

FIG. 6 shows the difference between tightly coupled traditional blockchains compared with the Consensus method of this invention which produces loosely coupled Orderings.

In FIG. 6 the reference numerals refer to:
61—Traditional tightly coupled Blockchain with pointers 64 embedded in blocks 62.
62—Blocks in traditional Blockchain.
63—Pointer to the latest Block in traditional tightly coupled Blockchain.
64—Pointers within Blocks pointing to a previous Block (and indirectly to all previous Blocks by repeatedly), such that cryptographic hashes are used pointers to ensure integrity between a block and the history that preceded it.
65—Ordering based view of consensus.
66—Blocks in an Ordering that are independent from other Blocks (do not contain pointers to previous blocks).
67—Ordering Data Structure (which will typically cryptographically verifiable structure such as a Merkle Tree which enables robust integrity checks) which maintains a list of blocks in a well-defined defined Ordering.
68—Pointer to the Ordering data structure (potentially the Value ID of root Cell in Ordering Value).
69—Pointer to the last Block in the Ordering.
610—Notation used to signify a pointer to a Block/other data structure, typically a cryptographic hash.

An Ordering SHOULD NOT be implemented as a tightly coupled linked list of Blocks [61] with pointers [64] that include the hash of to the previous Block [62] in each Block. Preferably, Orderings should be “loosely linked” [65] as contrasted to traditional “tightly linked chains” [61]. Pointer [68] links to a data structure [67], which may be a cryptographically verifiable structure such as a Merkle Tree used to represent an Ordering. This enables robust integrity checks to maintain a list of Blocks in a well-defined ordering. Blocks [66] in the “loosely linked” Ordering are independent from other Blocks, i.e., not containing pointers to previous Blocks.

An optional Pointer [63] may be used to designate the last Block in an Ordering. [610] is notation for any type of pointer.

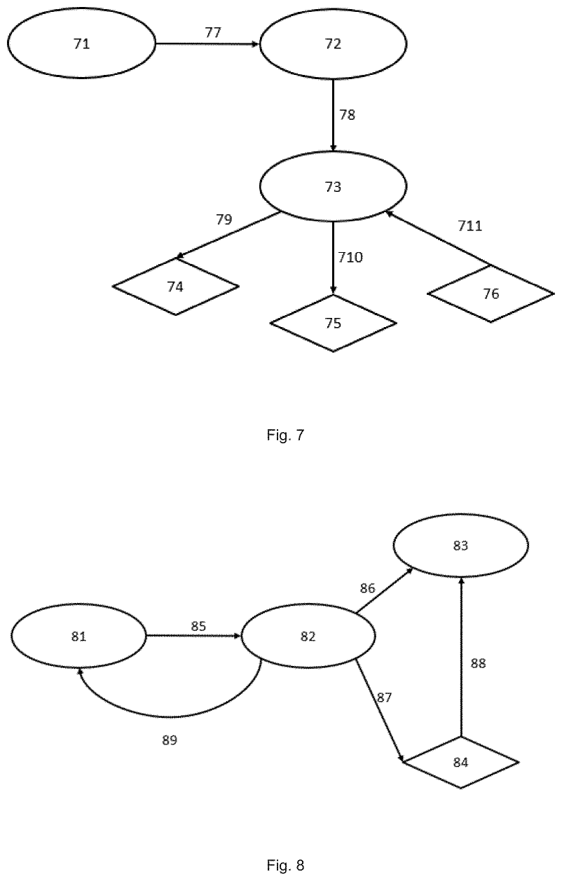

FIG. 7 shows a process for allocating rewards via pools of Incentive funds.

In FIG. 7 the reference numerals refer to:
71—Governance Account.
72—Long term block reward pool.
73—Current block reward pool.
74—Peer stake 1.
75—Peer stake 2.
76—Peer stake 3.
77—Allocation of funds.
78—Release of funds
79—Distribution of reward with weighted Stake to good Peer 1.
710—Distribution of reward with weighted Stake to good Peer 2.
711—Remove of Stake from bad Peer 3, returned to current block reward pool.

Rewards are structured in a set of Block reward Incentive pools, wherein:
A governance Account [71] maintains a record of all rewards and transfers [77] quantities of funds (e.g. a native coin) to a long term Block reward pool [72];
The short term Incentive reward pool [73] is intended to reward currently operating Peers, and pays out relatively quickly [79, 710] to add the Stake of good Peers [74,75]
Long term reward pools [72] are used to “top up” [78] the short term reward pool over time, ensuring a sufficient incentive for Peers [74-76] to operate over the long term.

Preferably, Rewards accumulate over time to Good Peers from:
Transfer of funds to a reward pool e.g. [77, 711];
Transfers from long term reward pools to the short term reward pool [78];
Optionally, transaction fees paid by Client Transactions, which could be added to the short term reward pool [73] to be shared by current stakers.
Receiving reward from the short term reward pool [79, 710]

A Bad Peer [76] may be penalised by “slashing” [711] where some portion of its Stake is subtracted and placed back in the short term reward pool [73].

FIG. 8 illustrates a process for distributing transaction fees for a single transaction.
In FIG. 8 the reference numerals refer to:
81—Client Account.
82—Transaction funds reserved.
83—Current Block Reward Pool (see also 73 for other use of this Pool).
84—Peer Stake.
85—Allocation of funds for signed transaction (placed in reserve).
86—Execution fees based on cost of executing transaction or smart code.
87—Optional direct payment of transaction fees to Peer.
88—Block fees paid by Peer to submit blocks, shared across many transactions.
89—Remainder of transaction funds not consumed by fees, return to Client.

When a transaction is initiated, a quantity of native coins is taken [85] from the User Account [81] and placed in a reserve to pay for the transaction [82].

During transaction execution, all Ops and runtime functions charge a small “juice” cost which is defined based on the computational complexity of the code executed. The total juice cost for a transaction is multiplied by a juice price to calculate a total execution cost [86] denominated in the native coin, which is transferred [86] to the current Block reward pool [83].

An optional direct fee [87] may be paid to the Peer responsible for submitting the Transaction, by adding this to the Peer Stake [84].

After all fees are paid, and remaining reserved coins are returned to the User Account [89]. An optional Block fee [88] may be paid by a Peer out of its Stake [84] (which may be shared across multiple transactions).

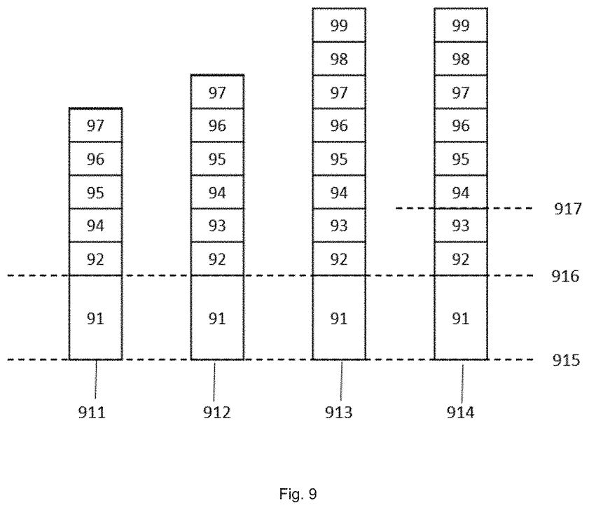

FIG. 9 shows changes to an Ordering for a single Peer as part of a Belief merge.

In FIG. 9 the reference numerals refer to:
91—Blocks already in Consensus Ordering.
92 to 99—Blocks proposed for Consensus.
911—Initial Peer Ordering (Consensus Ordering plus additional Blocks).
912—Winning Ordering as determined by Stake-Weighted Ordering Merge.
913—New Ordering with additional Blocks 98 and 99 added in timestamp order.
914—New Ordering with updated Consensus Ordering (advanced to position of new Consensus Point 917).
915—Start of Chain.
916—Original Consensus Point.
917—New Consensus Point.

A Peer's Ordering may be updated in accordance with the procedure for Stake-weighted Ordering merge:
The Peer starts with a Ordering in the first column [911]
The Peer computes a Winning Ordering on the basis of a Stake-Weighted Ordering Merge with ordering from other Peers (second column [912]), see also FIG. 5.
The Peer adds additional Blocks as necessary [98,99] in timestamp order to form its final updated Ordering [913]
Finally in [914] the Consensus is advanced to [917], subject to Computation of Consensus Ordering which determines which Blocks have sufficient support to be included in the Consensus Ordering
[91] designates an arbitrary number of Blocks already in the Consensus Ordering, between the start of the Ordering[915] and the current Consensus position [916].[92-99] designates Blocks additional to [91].

### Description of Key Components

This document uses definitions of words that may have specific meaning in the context of this invention, and are generally designated with upper case first characters. Definitions are provided in alphabetical order for convenience, but may reference other definitions and figures as required.

### Account

Optionally, an embodiment may incorporate a model of Accounts, in which case the following paragraphs apply:

An Account is an entity that may be owned or controlled by participants on the Network.

Preferably, a State may include information about each Account such as:
Balances of one or more native cryptocurrencies, such as Convex Coin;
Code uploaded by a user for Trusted Code Execution;
Information values controlled by the Account;
Security related information such as a public key used to verify Transactions submitted for an Account, or a nonce (an arbitrary number that can be used just once in a cryptographic communication) to prevent replay attacks.

Preferably, access controls are implemented such that only a correctly authorised Client (e.g. validated by a digital signature) can control the Account.

Preferably, an Account is identified by a unique identifier that refers to an Account, e.g. an Account address. Such an identifier should preferably remain consistent across State updates.

Optionally, an Account may be an autonomous Actor Account, which cannot be controlled by external Users. It operates according to pre-defined logic enforced by the Consensus Protocol (for example Trusted Code Execution). Actors are typically utilised to implement Smart Contracts.

Preferably, embodiments have additional facilities to support managing Account security, for example rotating a public key, or setting access control rules affecting other Accounts.

### Belief

A Belief is a set of information representing information relevant to Consensus held by a Peer

Preferably, a Belief is implemented as a single immutable Value, representing a snapshot of the Peer's understanding at a specific time.

Preferably, Beliefs may include such information as:
The latest known Ordering of Blocks announced by each Peer;
The list of all Blocks (or equivalently Transactions) validly included in Consensus;
A set of Transactions or Blocks proposed for Consensus, perhaps as a Proposed Ordering
The State of the network at different points in time, such as a list of States after each Block update;
A set of Beliefs, or data extracted from Beliefs held by other Peers.

Preferably, a Belief is implemented using a persistent immutable data structure comprising a tree of Cells using structural sharing.

Preferably, in most circumstances, only incremental changes to the Belief (which may be classed as Novelty) need to be communicated between Peers in the Network.

A Belief may be considered “valid” if it satisfies the Protocol for creating a Belief. A valid Belief must have been formed by correct application of the Protocol using data contained in the Belief, and consistent with any previous Beliefs broadcast by other Peers. Preferably, Beliefs are stored as a single Cell or Value, which may contain nested Values.

Preferably, a Belief may incorporate information sourced from one or more other Peers, which may optionally be signed with digital signatures to prove its authenticity and integrity.

### Belief Merge Function

A Belief Merge Function computes a new Belief from one or more other Beliefs.

Preferably, Belief Merge Functions are pure, deterministic functions of the form:

B=F(E,B1,B2, . . . ,BN)

### Where:

B=the new Belief generated
E=additional contextual information held by the Peer
B1 . . . BN=existing beliefs either held by this Peer or received from other Peers.

Preferably, properties of F are:
Associative over Beliefs, i.e. F(E, B1, F(E,B2, B3)) is equal to F(E, F(E, B1, B2), B3).
Commutative over Beliefs, i.e. F(E, B1, B2)=F(E, B2, B1)
Idempotent, i.e. F(E, B1, F(B1, B2))=F(E, B1, B2)

Preferably, embodiments use a Belief Merge Function of this form, in which case the properties of F are sufficient to ensure that Beliefs, under combination using the Belief Merge Function, constitute a Conflict-free Replicated Data Type (CRDT) and have the property of Convergence. Applying the Belief Merge Function to two or more valid Beliefs also produces a valid Belief. This can be guaranteed to produce valid Consensus under reasonable operating conditions.

### Block

A Block is a data Value including zero or more constituent Transactions.

Preferably, State update is computed on a whole Block of transactions at one time. Blocks may be submitted simultaneously by a Peer, known as the Block producer.

Preferably, Transactions are ordered within Blocks in a way that exactly defines the sequence by which they must be executed. However, Transactions that do not affect one another (i.e. do not have direct data dependencies) could be re-ordered or computed in parallel for efficiency purposes in an embodiment, providing that such re-ordering does not affect the resulting State.

Blocks are not essential in an embodiment of the invention. For example, each Transaction could be executed independently, but Blocks do provide some advantages for embodiments of the invention:
A Peer transmitting validated Transactions can sign the whole Block, rather than each individual Transaction;
State update batches reduce the frequency of State updates to be transmitted and stored;
Peers may be incentivised to perform efficient groups of Transactions

Preferably, and in contrast to traditional blockchains, Blocks do not need to contain a reference to previous Blocks [see FIG. 6]. Blocks may be re-ordered during Consensus without invalidating previous references.

Optionally, the execution of a Block may perform processing in addition to the execution of the individual Transactions, for example updating the State to incorporate the timestamp of the latest Block, or performing per Block accounting. This may be considered equivalent to the implicit inclusion of one or more automatic “per Block” transactions.

In this document, Blocks and Transactions may be used interchangeably, where the difference is not relevant.

### Cell

Cells are sub-components of Values, such that a large Value may be represented by multiple Cells (although a small Value may also be a single Cell).

An embodiment may choose not to make a distinction between Values and Cells, but the ability to make this distinction may provide various conceptual and implementation advantages.

Preferably, large Values are represented as a tree data structure of multiple Cells. Some of the consistent Cells may be Values in their own right, e.g. individual Values contained within a List data structure.

Preferably, a top-level Cell contains references to multiple child Cells. This allows large data structures to be represented as a Directed Acyclic Graph (DAG) of Cells and/or Smart References to Cells.

Preferably, it should be impossible for Cells to contain circular references. This can be ensured, for example, by making all Cells immutable, and using cryptographic hashes as identifiers so that it is infeasible to construct a Cell which directly or indirectly refers to itself.

Preferably, the size of each valid Cell is bounded by a maximum limit to size of data that may be encoded in a single Cell. This allows all Cells to be represented within a fixed-size memory buffer.

In this document, the terms Cell and Value may be used interchangeably, especially where the difference is not relevant.

### Client

A Client is a participant node in the network performing a role other than maintaining Consensus. Clients typically perform one or more of the following activities:
Observe or query aspects of the Consensus State
Submit transactions to Peers to be included in future Consensus

A Peer may also act as a Client when it performs actions outside maintaining Consensus. For example, a Peer acts as a Client if it submits a Transaction that increases its Stake.

### Common Prefix Computation

Common Prefix Computation is an approach for computing the longest number of contiguous elements of two ordered sequences that match starting from the beginning of the sequence (sometimes referred to in computer science literature as “longest common prefix”)

For example, consider the two ordered sequences:
[A, B, C, D, F, G]
[A, B, C, G, D]

In this case, the common prefix is [A, B, C] with prefix length 3.

Preferably, Peers use Common Prefix Computation to calculate the consistency of two or more Orderings. For example, any Orderings proposed by Peers are only consistent with a Consensus Ordering if and only if the length of the common Prefix is equal to the full length of the Consensus Ordering.

Preferably, Common Prefix Computation is implemented using data structures that allow the prefix to be computed in less than O(n) time, where n is the length of compared structures. For example, O(log n) is achievable by preferred embodiments. Conventional (naive) algorithms might have unacceptable performance checking the common Prefix of long Orderings, operating in O(n) time, where n is the length of the compared Orderings. They may need to process millions of Blocks with unacceptable latency and unaffordable computational costs.

Preferably, Common Prefix Computation combines Merkle Trees, trees with embedded cryptographic hashes, with tree structures such as Radix Trees to compute common prefix lengths. Efficient prefix computation is therefore possible in O(log n) time. An embodiment may achieve this by:
Storing sequences of elements as “Vectors”, where a Vector is a data structure that contains an arbitrary sequence of Values;
Implementing a Vector as a tree (e.g. a Radix Tree), where each tree node has a constrained number of child nodes, for example up to 16;
Computing the cryptographic hash of each node and including this in a parent node (a “Merkle Tree”)
Examining hashes in each tree node to find the first pair of nodes with different hashes (which means that the two nodes must contain the first difference) and recursively examining these two nodes until the position of the first different element is found.

### Computation of Consensus Ordering

The Computation of Consensus Ordering (Computation) is the method by which Peers determine a new Consensus Ordering, preferably implemented by embodiments as part of the Belief Merge Function, as shown in FIGS. 2, 5 and 9.

Preferably, Peers are able to compute an updated Consensus Ordering from information contained within a Belief (most commonly a merged Belief with updates from other Peers).

Preferably, the Belief contains Orderings proposed by other Peers in the Network, such that the Computation may rely on such information. This might be achieved in a mathematically idempotent way, for example, by including the Ordering that has the latest timestamp from each Peer.

Preferably, the Computation is performed in a way that is mathematically idempotent, such that it satisfies the desired properties for inclusion in the Belief Merge Function.

Preferably, the updated Consensus Ordering will be equal to the previous Consensus Ordering, plus zero or more additional Blocks that are confirmed in the new Consensus.

Preferably, the new Consensus Ordering will include all Blocks that are proposed for Consensus by a defined fraction of participating Peers (for example, ⅔ of Peers as determined by Stake weight).

Preferably, the Computation includes a method for Peers to distinguish between the actual Consensus Ordering they hold and their proposal for a new Consensus Ordering (the “Proposed Ordering”). For example, Peers might communicate a longer Ordering as well as two numbers that indicate the number of Blocks (numbered from the beginning of the Ordering) that the Peer considers to be the latest Consensus Ordering, as well as the number of Blocks considered to be the Proposed Ordering. There may be additional Blocks in the Ordering beyond these numbers, which are in neither the Consensus Ordering or the Proposed Ordering of the Peer.

Preferably, Peers will utilise a form of “two-phase commit” in the Computation, where they first create a Proposed Ordering, then confirm it as the new Consensus Ordering only when this proposal is confirmed by a sufficient number of other Peers (for example, ⅔ of Peers as determined by Stake weight).

Preferably, Peers will propose a new Proposed Ordering if they determine that this is likely to form the new Consensus Ordering. For example, they may only include Blocks in the Proposed Ordering once a sufficient number of other Peers are observed to be placing the same Blocks in the same positions in their respective Orderings (for example, ⅔ of Peers as determined by Stake weight), as shown in FIG. 5.

Preferably, for Blocks that a Peer is unable to confirm in either the Consensus Ordering or Proposed Ordering (perhaps because of multiple competing proposals, none of which has sufficient voting support) the Peer should construct an Ordering including these Blocks which is most likely to be supported by other Peers in the future, thus facilitating convergence towards a common agreement. The Stake-Weighted Ordering Merge may be used for this purpose.

Preferably, the whole Computation is constructed to have the property that repeated application of Belief Merges by all Peers is guaranteed to converge to a single Consensus Ordering assuming properties such as:
A sufficient proportion of Peers correctly follow the Protocol (e.g. ⅔ of voting Stake)
The Network continues to be connected so that Peers can communicate directly or indirectly

See “Consensus Properties and Proof” for a more detail description of this construction as it may be applied in an example embodiment

### Consensus

Consensus is the agreement of a set of Network nodes on one or more information values.

An information Value may be described as being “in Consensus” if it has been directly agreed by Peers following the Consensus Protocol (e.g. an Ordering of Blocks), or if it can be computed from Values already in Consensus (e.g. the computation of the latest Consensus State from previous Blocks)

Preferably, the Consensus is designed to include the Consensus State so that this is agreed by network participants

Preferably, the Consensus is designed to include the Consensus Ordering, so that this can be used to Compute the Consensus State and/or any States preceding the Consensus State (potentially as far back as the Initial State).

An illustration of Consensus State Update as may be implemented in an embodiment is provided in (FIG. 3).

### Consensus Ordering

A Consensus Ordering is the Ordering of Blocks (or equivalently Transactions) that a Peer has confirmed to be in Consensus, as seen e.g. in FIG. 3.

Preferably, given a Consensus Ordering, a Peer can compute the Consensus State given any previous State and the corresponding sub-sequence of Blocks between that State and the end of the Consensus Ordering, by repeated application of the State Transition Function.

### Consensus Properties and Proof

Preferably, the Consensus Protocol can be shown to converge to a Consensus that is stable and can be considered final by participants in the Network assuming relevant assumptions are met.

Preferably, the only Blocks included in Consensus are valid blocks that have been proposed by Peers, e.g. as validated by digital signatures provided by such Peers. A small number of bad Peers cannot get a bad Block accepted.

Preferably, The Proposed Ordering and Consensus Ordering for a good Peer are only communicated when the Peer observes a majority of Peers supporting it. If this is the case, then good Peers will never change their opinions, and such Orderings may be considered final.

Preferably, Embodiments are designed to provide Byzantine fault tolerance and are robust with up to ⅓ of bad Peers by voting Stake. A sketch proof of this property is:
Assume the proportion of bad Peers is b, where b<⅓
Assume a threshold of ⅔ for Consensus for a good proposal has been reached
Since ⅔−b>b, then bad Peers have less voting stake than good Peers in Consensus,
In a worst case scenario, if all bad Peers initially supported the good proposal but switch votes simultaneously to a new, bad proposal, then the bad proposal still has fewer votes than the good proposal. The remaining good Peers observe the higher vote of the good Peers and confirm the good Consensus. Bad Peers are unable to stop the good Peers reaching a new ⅔ Consensus.

### Consensus Protocol

The Consensus Protocol is the procedure followed by Peers in order to compute the updated Consensus State.

Preferably, The Consensus Protocol enables Peers to compute Consensus on multiple Blocks in parallel by not requiring Blocks to contain cryptographic hashes of previous blocks. This reduces latency in embodiments.

Preferably, Consensus is maintained over State updates using the following procedure as part of the Protocol:
Valid Beliefs include a Consensus Ordering that represents the latest Consensus Ordering observed by the Peer producing the Belief
Peers share Beliefs between themselves. If the network is constrained by capacity, they preferably give priority to sharing Beliefs with higher staked Peers.
Peers merge Beliefs that they receive using the Belief Merge Function satisfying CRDT properties. As part of this, Computation of an updated Consensus Ordering may be performed
Peers are able to obtain the updated Consensus Ordering from the merged Belief, and any other relevant information
Peers utilise the Consensus Ordering to compute the latest Consensus State as necessary.
Peers may optionally add additional data to their Belief, for example appending additional Blocks to their Ordering for consideration in future Consensus
Peers communicate their updated Belief to one or more other Peers
Peers optionally communicate results back to Clients (for example, the result of Transactions submitted by Clients with the intention of effecting changes in the Consensus State).
The procedure repeats as necessary.

An illustration of the Belief Merge Process as part of the Consensus Protocol is provided in FIG. 2 and further described as part of the example embodiment.

### Consensus State

The Consensus State is the State that a node considers to be the latest version of the State, considering the latest Consensus.

It may be possible for difference nodes to have different opinions on the value of the Consensus State (allowing for different speeds of propagation across the Network, for example)

Preferably, in embodiments where the State is determined by application of a State Transition Function to an Ordering of Blocks, the Consensus State is The State immediately following the latest Block in the current Consensus Ordering.

Preferably, participants in the network should consider the Consensus State as the reliable source of truth regarding all information managed by the network, although they may optionally refer to previous States for various purposes such as historical analysis.

### Convergence

Convergence is the property of a system where information values are caused to converge to identical values over time. Such a system may be termed “Convergent”

Preferably, an embodiment makes use of the Convergence property to achieve Consensus in a manner similar to a CRDT.

Preferably, Convergence can be arranged so that some portions of information values are arranged to converge before others, for example the earlier Blocks in Orderings are caused to Converge to the Consensus Ordering before later Blocks.

### Convergent Storage

Convergent Storage is a system of Storage where the action of storing some information has the property of Convergence.

Preferably, such actions are commutative, idempotent and associative. These properties taken together enable the state of the Storage system to operate in a manner similar to a Convergent Replicated Data Type (CRDT), allowing values to be stored reliably in a conflict-free manner. Under this model, new information may be merged into Storage at any time without changing or invalidating existing information.

Preferably, any action performed on a Convergent Storage system will result in an operational state of the Convergent Storage system that is guaranteed to be consistent with all previous versions of Storage. Properties of this consistency should include:
If a Value existed previously in storage, it will still be accessible
New Values are purely additive, such that it is impossible to alter, remove or overwrite existing Values (since these should preferably be immutable)
If Monotonic Header information of new values is different, Monotonic Headers can converge to a single “maximum” value, since the update of Monotonic Headers is also commutative, idempotent and associative

Preferably, Convergent Storage is configured to store Cells referenced by Value IDs.

Optionally, Convergent Storage implementations may allow “garbage collection” to remove stored Values that are no longer needed. This operation should not affect the behaviour of the Storage System, provided that references are no longer held that are subsequently used to request data that has been removed.

Preferably, embodiments incorporate a Convergent Storage system that exhibits some or all of the above properties.

### CRDT

A CRDT is a “convergent replicated data types”, as generally understood in computer science literature. Such CRDTs are known to have the property of Convergence when shared under various configurations of network communications (e.g. “random gossip” models).

Preferably, Beliefs have the property of being a CRDT, such that they may be merged by the Belief Merge Function to automatically resolve inconsistencies (the Belief “Converges” to a consistent value).

Preferably, sets of information in the Storage subsystem also behave as a CRDT, so that new information can be reliably merged into Storage without conflicts.

### Encoding

An Encoding is a representation of the information contained in a Cell typically using zero or more lower level information units.

Preferably, an Encoding is defined to be in a convenient form for storage or network transmission e.g. a sequence of 8-bit bytes as implemented on typical computing systems. For example, a Cell representing the number “1” might be encoded by the two bytes “0801” as represented in hexadecimal.

Preferably, the Encoding contains all relevant information in a Cell so that no information is lost when encodings are constructed, and an equivalent Cell with identical information may be reconstructed in its entirety from the Encoding.

Preferably, each distinct Cell is assigned a unique Encoding. The reverse may not be true, for example some byte strings may not represent a legal Cell.

Preferably, each Cell or Value has one and only one valid Encoding, which may be termed the “Canonical Encoding”.

Preferably, the encoding process may “embed” small Cells within a larger Encoding to reduce the need for separate encodings and storage for small values. For example, an embodiment may be configured to automatically embed Encodings of 140 bytes or less. within the encoding of any parent Cell. Such encodings are referred to as Embedded.

Preferably, the Encoding may incorporate references to other Cells (e.g. by encoding a representation of the target Cell's Value ID. In such cases, it may be necessary to obtain the referenced Encodings to fully reconstruct a Value (or tree of Cells) in their entirety.

Preferably, the Encoding of any Cell has a defined maximum size so that any valid Encoding can be proved to fit inside a fixed size buffer of lower level information units (e.g. a byte buffer).

### Incentives

Preferably, Embodiments implement Incentive mechanisms (see e.g. FIGS. 7 and 8) to encourage honest, efficient and value-creating participation. The computation and execution of these Incentives can be performed while computing State updates, either through rules encoded in the Protocol itself or via Smart Contracts. Incentives may include, but not limited to:
Transaction fees for Clients, which may be required by Peers for submitting Transactions for Consensus on behalf of Clients;
Block fees for Peers for bundling many Transactions into larger blocks, which increases the efficiency of the Consensus processes;
Block rewards for Peers or Clients who place Stake on good Peers;
Penalties for Peers proven to have used the Protocol inconsistently;
Discretionary payments to actors that provide valuable services to the network;
Pools allocated a portion of fees from other Pools to provide other Incentives, such as network governance costs.

The size of Incentives may be determined in a number of ways:
Fixed at the network level;
Dynamically computed, such as based on Transaction computational cost or a Peer's level of Stake;
Adjusted by Network governance protocols, such as a Transaction signed by a governing body that adjusts Incentive calculations and updates the Network state;
Managed off-chain by organisations handling Network governance

Incentives may be distributed via a number of processes:
Directly transferring value to or from Accounts;
Adjusting the Stake of a Peer;
Allocating Tokens via Smart Contracts;
Channelling Incentives through Pools covering any combination of the above.

### Initial State

The State before any Blocks are applied is known as the Initial State.

Preferably, all Peers in the Network are arranged to have knowledge of the same Initial State. Peers may wish to confirm the Value ID of the Initial State, in order to guarantee that they are computing the same Consensus State.

### Invalid Beliefs

Invalid Beliefs may be created by Nodes that fail to implement the Consensus protocol (either deliberately, or as a result of defects).

Preferably, all Beliefs received from untrusted Peers should therefore be tested for validity before applying the Belief Merge Function. The following techniques may be used by embodiments to flag invalid Beliefs and exclude them from Consensus:
Checking cryptographic signatures and Peer registration on the network;
Checking data structures such as bad data formats;
Checking timestamps for Beliefs that are old to be included in Consensus;
Checking the idempotence property of the Belief Merge Function, that is F(latest belief, previous belief)=latest belief

Preferably, after detecting invalid Beliefs, good Peers may take one or more of the following actions:
Ignore the Belief for further Consensus processes;
Blacklist a Peer, disconnect it and prevent new connections;
Challenge a Peer, based on the invalid belief, which may result in a bad peer losing some or all of their Stake (via Slashing).

### Memory Accounting

Memory Accounting the method of attributing usage of memory and/or storage to participants in the Network.

Preferably, Memory Accounting is used to create an economic incentive for participants to minimise memory and/or storage usage, thus improving the overall efficiency and scalability of the Network.

Preferably, Memory Accounting operates by utilising Memory Size computations

Preferably, Memory Accounting is applied to Transactions that alter the Memory Size of the Consensus State, attributing the change in memory size to the Account of the participant that signed the Transaction.

Preferably, participants should be required to make a payment (e.g. in a native cryptocurrency available on the Network) in order to increase the Memory Size of the State.

Preferably, participants should receive a refund (e.g. in a native cryptocurrency available on the Network) if they reduce the size of the State.

Preferably, participants may be charged a payment for other actions that they execute on the Network which consume memory resources, for example:
A fee proportionate to the Memory Size of a Transaction that is executed on behalf of a Client;
A fee proportionate to the Memory Size of a Block proposed by a Peer

### Memory Size

Memory Size is a measure of the total size of information contained within Cells (or equivalently Values),

Preferably, the Memory Size is defined to be inclusive of the size of other child Cells which may be indirectly referenced (e.g. via Smart References)

Preferably, Memory Size is an approximate measure of the number of bytes required to store or transmit a Cell that might include:
The size of the Cell's Encoding;
The sum of the Memory Sizes of any child Cells (recursively defined);
An allowance for indexing and storage overheads.

Preferably, if an implementation supports Embedded Cells (as defined in the Encoding) which do not require storage in their own right then these may be defined to have zero Memory Size. However, it should be noted that the size of such Embedded Cells should be accounted for in the Memory Size of any Cells with an Encoding that includes the Embedded Value.

Preferably, Memory Size is only calculated when required, such as when the State resulting from a Transaction is persisted to Storage. This minimises the computational costs accounting for transient in-memory objects, enabling memory sizes to be cached and improve performance. Caching the Memory Size in metadata attached to Cells in memory or Storage (as part of a Monotonic Header) is the preferred approach.

### Monotonic Header

A Monotonic Header is additional metadata that may be associated with a Value or Cell Encoding.

Preferably, the Monotonic Header is accompanied by a “merge” function that is commutative, associative and idempotent. This creates a structure that functions equivalently to a “join-semilattice” as commonly defined in mathematics. This ensures that headers can be merged and converge to a single value, consistent with having the Convergence property and/or being included in a CRDT.

Preferably (and as a logical implication of the above properties), the merge function ensures that information contained in Monotonic Headers can only change in one “direction”, such as an increasing integer or a sequence of State flags that relate to a graph that does not contain loops (a DAG).

Preferably, Monotonic Headers include status tags for nodes to indicate the progress of processing Cells or Values from the perspective of a Network participant. For example, the sample embodiment includes status tags for:
UNKNOWN—A Peer has a Value ID hash but does not know if it is consistent with an Encoding and may not possess the data in memory or Storage;
STORED—A Peer has encoded data in Storage which is validated to be a well-formed Cell (ignoring children), and consistent with the Value ID hash;
PERSISTED—A Peer has validated the structure of the Cell completely, including recursively validating all its children. At this point, a data Value within the Cell is safe to use in a computational process by a participant;
ANNOUNCED—A Peer has included the data in a publicly broadcast Belief;

Preferably Other possible tags include:
EMBEDDED—A data Value may be embedded within other Cells, and does not need to be individually stored;
INVALID—A Cell is provably inconsistent with one or more validation rules. Invalid data cannot be used for Consensus, but caching the invalid status may avoid the need to repeat a validation process.

Preferably, Monotonic Headers may include cached information that can be computed in a deterministic way from a Cell or Value, such as the Memory Size of a Cell. This usage of cached information may improve performance of implementations by reducing or eliminating the need to re-compute such values multiple times. The calculation of such a cached value is commutative, associative and idempotent since the only valid change is from an “uncomputed” state to “computed”.

### Network

A Network is a collection of nodes arranged to communicate with each other. A Network may be regarded as a single system, consisting of sub-systems representing the individual nodes.

Preferably, the nodes are included for the purpose of participating in the operation of the Consensus Protocol (for a Peer) or interacting with the Consensus being maintained (for a Client).

Preferably, a Network uses standard and well-known communication technologies, for example the Internet.

The Network preferably operates so that communication is possible between all nodes at all times. Temporary failures may cause the network to cease to be fully connected (a “network partition”). Individual nodes may leave or join the Network at any time.

An example Network is depicted in FIG. 1.

Novelty is a quantity of information (for example a Cell, or a set of Cells representing a Value or part of a Value) that is considered by a network participant (typically a Peer) to have been created or observed for the first time.

Preferably, an embodiment detects Novelty to ensure that a participant node only transmits new information to the Network, and does not re-transmit information that is not new, thus reducing processing or network bandwidth usage.

Preferably, Novelty may be detected by the Monotonic Header of a stored Cell representing being updated to some higher status level for the first time, e.g. transitioning from a status of PERSISTED to ANNOUNCED.

Preferably, Novelty detection is employed to increase the efficiency of embodiments, for example:
A new Belief only need to append an increment in the proposed Ordering, without communicating the complete Ordering, which may be very long, but likely to held by all other Peers;
Re-computation of validation is not needed on parts of the data that have already been validated, which may be important for large data structures where only small changes are required to validate a Consensus State.

Preferably, embodiments include a Convergent Storage system that is capable of efficiently detecting and applying rules relating to Novelty, e.g. through the use of status tags in a Monotonic Header.

### Ordering

An Ordering is a Value which specifies the order in which Blocks, (or equivalently Transactions) should be executed. The order represented may be total or partial (as commonly understood in mathematics)

Optionally, Orderings may incorporate additional data, for example:
A sequence of all State transition results, previously computed up to the confirmed point of Consensus;
Pointers to the position of Current or Proposed Consensus in the Ordering;
Additional Blocks that have been submitted by a Peer, but not yet included in the current or proposed consensus;
Other information relevant for communication between Peers.

Preferably, an Ordering is digitally signed by a Peer, to provide proof that the Ordering was legitimately created by the associated Peer. Peers may ignore Orderings that are not correctly signed.

Preferably an Ordering used loosely coupled Blocks (see FIG. 6)

Preferably, embodiments using Orderings enable high scalability and low latency, for example by permitting concurrent creation and re-ordering of independent Blocks before Consensus is reached. In traditional tightly coupled ordering, all previous Blocks have to be created and confirmed before a new block can be added.

Preferably, an Ordering is represented as an immutable persistent data structure with structural sharing, such that the earlier Blocks in the Ordering are shared with new versions that append additional new Blocks. By this method, only new Blocks added to the Ordering might be considered as Novelty. This is an important optimisation that may reduce memory consumption and network transmission, especially when large numbers of large Orderings are being shared on the Network.

### Peer

A Peer is a node in the Network which participates in maintaining Consensus.

Preferably, a Peer should behave strictly according to the Consensus Protocol, however the overall Consensus is designed to be robust and secure even in the presence of some “Bad Peers” that fail to follow the Protocol correctly.

Preferably, a Peer has an associated Stake, representing an economic commitment to act faithfully. A peer may lose its Stake if it is proven to be a “bad actor”. Attempting to modify Consensus without following the Protocol is not permitted, such as unauthorized withdrawal of funds from a User Account. Peers with zero Stake may be ignored or de-registered by other Peers.

### Scheduled Execution

Embodiments may optionally implement a system of Scheduled Execution, in which case the following paragraphs apply:

A Schedule is a data structure that may be included in a State to specify transactions to be executed at a future time.

Preferably, Scheduled Execution is the execution of transactions from the Schedule as part of the State Transition Function (and by implication this should be enforced and verified by the Consensus Protocol).

Preferably, Scheduled Execution depends on a timestamp that has been confirmed by Peers as part of the Consensus Protocol. For example, the timestamp might be defined to be the most recent timestamp observed out of all Blocks executed so far to produce the Consensus State.

Preferably, a timestamp should be included in the State itself, so that it is also available for Trusted Code Execution and can be examined and verified by participants.

Preferably, the Schedule is represented with a data structure designed to support efficient indexing, so that the next Transactions to be executed can be efficiently queried, and so that already executed transactions can be removed. An example of such a data structure would be a “radix tree”.

Preferably, access controls are applied to Scheduled Transactions similar to regular Transactions or Trusted Code Execution so that they cannot make unauthorised changes to the State.

### Smart Contracts

A Smart Contract is a computer program or protocol that digitally facilitates, verifies, or enforces the negotiation or performance of a contract.

Optionally, embodiments may support the implementation of Smart Contracts on the Network, such that their reliable execution is validated and enforced according to the Consensus Protocol.

Preferably, Smart Contracts have the ability to control resources managed within the on-chain State of the network, such as native cryptocurrencies or user-defined tokens. This control might, for example, involve transferring ownership of digital assets between Users if certain predefined conditions are met.

Preferably, independent parties can trust and verify the behaviour of the Smart Contracts, based on the assumption that the Network operates correctly according to the Consensus Protocol.

Preferably, Smart Contracts are implemented using the facility for Trusted Code Execution on the Network (assuming this is available in the embodiment).

Preferably, Smart Contracts are implemented so that execution can be computed deterministically from information in Consensus, such as the current State, Transactions and other inputs to the State Transaction Function. As long as the inputs to Smart Contracts are in Consensus, the outputs of execution can be verifiably proved to be in Consensus.

Preferably, Smart Contracts are activated by submitting a Transaction which calls the Smart Contract (either directly or indirectly). They could also be automatically invoked by other processes in the Protocol, such as at predetermined timestamps.

In embodiments, Smart Contracts may be implemented with various features, for example:
Exporting externally accessible functions;
Accepting input parameters for exported functions and returning results as outputs;
Call other Smart Contracts and executing additional Transactions on the Network;
Limiting the computations with pre-set constraints on computational units accountable to the Transaction Client;
Creating and deploying other Smart Contracts;
Charging fees for executing the Smart Contract computations. Fees may be paid to the Peer who published the transaction on behalf of a Client. Payment, possibly in cryptocurrency, may be paid into an incentive pool, as commission to an arbitrary third party or other agreed methods;
Scheduling code for future execution, subject to defined rules.

### Smart References

Smart References are pointers to Cells (or equivalently Values)

Preferably, Smart References use Value IDs as identifiers. Assuming that Values are immutable, this means that the Smart Reference must always refer to the same immutable information.

Preferably, Smart References allow “garbage collection” of Cells or Values, particularly when it is known that the data has been written to storage and is not currently in use, thus freeing up working memory in the host system. Embodiments might implement this using Java “Soft References” via the Java Garbage Collector.

Preferably, Smart References incorporate a mechanism so that data can be restored from the Storage if data previously garbage-collected from working memory data is needed for future processing. Cryptographic hashes as Value IDs ensure that restored data is identical to the original Values, having an identical Encoding. Additionally, Smart References may request “missing data” from another Peer if a Value cannot be retrieved directly from Storage.

### Stake

Stake is a quantity of an asset that may have an economic value.

Preferably, an embodiment enforces a requirement for participants to provide Stake under certain circumstances. This provides security by encouraging good behaviour from network participants (who may be at risk of losing their Stake if they do not behave correctly).

Preferably, Peers are required to provide a Stake in order to qualify for participation in Consensus, termed Peer Stake.

Preferably, the Stake of Peers is recorded as part of the State, so that knowledge of the Stake of each Peer can be obtained from Consensus

Preferably Peer Stake may provide voting rights in the Consensus Protocol. During Consensus processing, Stake may be considered “locked up” and cannot be used for other purposes.

Preferably, Peers that do not behave correctly according to the Consensus Protocol may be penalised by removing some or all of their Stake, known as “Slashing”. Such penalties may be defined as part of the protocol, or triggered by other participants.

Optionally, Stake may be increased as a reward for processing Transactions. See [FIG. 7] for an example illustration of how reward pools may be structured in an embodiment to reward Peers by increasing their Stake.

Optionally, Users and/or Clients may place Stake in addition to Stake placed by Peers, known as “Delegated Stake”.

Typically, placing a Stake may entail both risks and responsibilities. For example, Peers may be required to maintain the secrecy of their private keys, otherwise they risk losing their entire Stake to malicious actors.

### Stake-Weighted Ordering Merge

A Stake-weighted Ordering Merge (Ordering Merge) is a process whereby conflicts may be resolved between Orderings.

Preferably, embodiments resolve conflicts between Orderings proposed by different Peers by performing a State-weighted Ordering Merge, and preferably in such a way that is consistent with delivering the desired Consensus Properties and Proof.

Preferably, the Ordering Merge is applied to all Blocks after the current Consensus Ordering.

Preferably, the Ordering Merge excludes Peer Orderings that are not consistent with the Consensus Ordering of the Peer performing the Ordering Merge (e.g. if a Peer Ordering does not match exactly the Blocks of the Consensus Ordering up to the entire length of the Consensus Ordering, it is ignored).

Preferably, embodiments resolve conflicts between proposed Orderings by performing a State-weighted Merge,

The system for inclusion of peers in an initial voting set based for participating in the Stake-weighted Merge is illustrated in FIG. 4.

Preferably, Peers compute the Ordering Merge according to the following procedure:
1. Each Peer computes the initial “voting set” of all peers with consistent Consensus e.g. peers whose Orderings agree match up to the position of the Consensus Ordering maintained by this peer. The current Peer is automatically included in this set (since it must, by definition, agree with itself). This may include peers which are “lagging” (have a shorter Consensus Ordering, but which whose Orderings are otherwise consistent with the Consensus Ordering of this peer) and “advanced” (which have already announced Consensus Orderings longer than but still consistent with this Peer) but should exclude peers which are inconsistent with the current Consensus Ordering (which may be true in the case of a consensus fork, no proposal, or an out-of date proposal). See [FIG. 4] and corresponding explanation above.
2. A “Winning Ordering” is determined (see FIG. 5), which is determined by the following procedure:
   i) It is initialised to be the Consensus Ordering of this peer
   ii) A weighted stake is computed for each peer in the set (e.g. peer A may have 2.3% of the vote among the given set)
   iii) The next Block with the highest total vote among the set (this is termed the “Winning Block”) is appended to the Winning Ordering
   iv) Peers which are no longer consistent with the Winning Ordering (i.e. did not vote for the Winning Block) are excluded from the voting set (it is also possible for inconsistent peers to be given a reduced weight rather than removed completely, though preferably suggest setting weight to zero is optimal)
   v) If any Peers remaining in the voting set have additional Blocks in their Ordering then go back to ii) and repeat for the next block position.
3. Once all blocks in the voting set have been selected, the final Winning Ordering is defined [512]. This will be (as a consequence of the above voting rules) exactly equal to the Ordering of any peers (one or more) which remain in the voting set (refer also to FIG. 5 which illustrates the final Winning Ordering computed as the longest Ordering remaining that is consistent with all previous winning rounds.)
4. Blocks which have been observed but are not already included in the Winning Ordering chain (e.g. new Blocks offered by a peer that was excluded from the voting set) may be appended to the Winning Ordering (for example in timestamp order). This ensures that all Blocks are ultimately included in the Ordering proposed by a Peer. In addition, using block timestamps to inform the Ordering maximises the likelihood that the proposed ordering is consistent with orderings proposed by other peers, which improves efficiency and minimizes consensus-finding latency.
5. The resulting Winning Ordering then becomes the new Ordering for this peer, and is included in the peers' Belief for subsequent transmission to the network.

See FIG. 9 to see how the final result of the Ordering Merge might be updated in accordance with the procedure described above:

### State

A State is a Value representing data that can be computed or updated as a result of Consensus.

Preferably, the State includes information of interest to Peers and Clients of the Network, such that they may derive value from this information, This may include, but is not limited to:
Holdings of cryptocurrencies or other digital assets controlled by participants in the Network
Peer records identifying and describing a Peer in the network, such as Stake and network address
Information stored or updated by Users
Executable Smart Contract code
Global data, such as Network status and other data accessible to Smart Contracts.

Preferably, the State is implemented using a data structure that facilitates fast access to and update of information contained in the State, such as by providing an efficient index for Account access.

Preferably, a State implemented as a Value, so that the entire State can be represented as a single immutable information unit.

Information included in the State, or involved in processes that update the state may informally be referred to as “on-chain”.

### State Transition Function

A State Transition Function is a function that enables the computation of an updated State. Preferably, the mathematical model for state transition may be considered to be of the form:

S(t+1)=f(S(t),T,E)

Where:
f=the State Transition Function
S(t)=the State prior to the execution of the State Transition Function
S(t+1)=the new State after Execution of the State Transition Function
T=a Transaction (or Block of multiple transactions) to be applied to the state
E=additional environmental context, if any (e.g. random number sources)

Preferably, executions of a State Transition Function are deterministic with respect to inputs, so that all Peers computing the State update correctly will agree on the resulting State, given the same initial State and Transaction input. This implies that the nodes must also agree on the same environmental context.

Preferably, State Transition Functions are computable in bounded time and space, so that they can be executed on Peer machines with reasonable specifications in terms of storage, network and computational resources.

A State update may be termed “valid” if it has been computed in accordance with the Protocol rules and the correct application of a State Transition Function.

Optionally, not all Peers are required to compute State updates, provided that they receive the resulting State in future, when consistency can be maintained. Situations where this may occur include:
Delegating to a subset of Peers, for example if they have access to private data not available to all Peers;
Catching up after disconnection or joining the network as a new Peer, in which case it may be more efficient to simply obtain a recent State from another Peer rather than recomputing a large number of previous State updates.
Trusting another Peer to compute the new State correctly. Note that this potentially puts a Stake at risk if the trusted Peer does not perform a valid State update.

Preferably, embodiments implement a State Transition Functions that supports the typical requirements of a decentralised ledger system. These may include:
Executing Transactions according to the instructions provided by clients, so that these may update the Consensus State;
Protecting User Accounts or digital assets that can only be modified if a correct digital signature is provided;
Calculating Transaction fees so that there is an economic incentive for users not to submit wasteful Transactions;
Updating Peer information, such as Stake or network address, subject to checking a Peer's digital signature;
Distributing rewards to Peers, such as payments from an incentive pool and rewarding Peer for providing network resources;
Executing code (including Smart Contracts) in a predictable and secure way as requested by Client Transactions or other triggers;
Managing balances and ownership of digital assets, such as a native cryptocurrency or user-defined tokens, or NFT-s.

### Storage

Storage is a method, system or process whereby any Cells (or equivalently Values) (and optionally other information) can be persisted on durable storage media to be retrieved when required.

Preferably, Storage is used to prevent loss of information in the event of system failure, and to allow large amounts of data to be stored that may exceed the working memory capacity of a single computing system (e.g. a server operating a Peer)

Preferably, the cryptographic hash of the Encoding of a Cell is used as a Value ID (VID) to refer to a Cell. VIDs may be used as a key for efficiently addressing data in an indexed storage system.

Preferably Cells referenced in a Storage system are immutable. Data Values cannot change for a given key, which would invalidate its VID. Immutability has advantages in embodiments:
Stored Cells are not re-sized and the database can be increased with an “append-only” restriction that minimises storage fragmentation;
Caches are always valid and replicas do not require synchronisation;
Verification is rapid if a hash exists in Storage, after data has been validated, it is always valid.

### Transactions

Transactions are information units representing a message or instruction to the Network which may affect one or more information values in Consensus.

Preferably, Transactions include a digital signature, so that Network participants can validate that the Transaction has been correctly signed by an appropriate private key, and so that such transactions can be assumed to have access privileges associated with that key (e.g. the ability to execute instructions to transfer digital assets from a specific User Account).

Preferably, Transactions are designed to update the Consensus State in embodiments of the invention. Transaction processes may include:
Computations, such as transferring funds or triggering smart contracts, that update the network State;
Cryptographic signature by the Transaction originator to ensure security. For example, only Users with correct private keys can spend currency from their own Accounts
Applying updates to a given State that may either succeed as specified or fail, for example if an Account has insufficient funds.

Preferably, an embodiment provides a mechanism for recording and communicating results of transactions back to Clients (in particular to the Client that submitted the Transaction, if the transaction was submitted by a Client)

### Trusted Code Execution

Trusted Code Execution (or simply Code Execution) is the execution of programmatic code as part of the State Transition Function, according to rules which may be defined by an embodiment.

This capability is optional for embodiments, but if embodiments choose to implement Trusted Code Execution then the following paragraphs should apply:

Preferably, facilities exist so that Network participants can upload or deploy their own code to the Consensus State, e.g. by issuing an appropriate Transaction.

Preferably, Trusted Code Execution is constrained by access control rules, so that the execution of Code cannot make arbitrary changes to the State (for example, taking control of digital assets owned by another arbitrary User)

Preferably, Trusted Code Execution has the facility to implement Turing Complete computer programs, so that arbitrary logic can be implemented. This might be implemented in an embodiment using a custom VM with defined opcodes.

Preferably, a mechanism is included to limit the computational costs of Code being executed, so that a User cannot consume excessive computational resources. This might be implemented, for example, by imposing a transaction fee for each Code operation executed, and aborting execution if limits are exceeded.

Preferably, the working memory requirement should be bounded per transaction, such that execution of transactions can be completed safely in implementations with a limited working memory size. The ability to offload data to Storage may assist this.

Preferably, Trusted Code Execution supports atomic operations, such that either the execution of an atomic operation succeeds entirely, or changes are rolled back in the case of a failure. An embodiment might choose to implement the entire Transaction as an atomic operation, or allow Code to define custom atomic operations.

### User

A User is a person, or legal entity, that can perform actions and may hold or control assets on the Network, and hence may be considered an indirect participant in the Network.

Preferably, a User interacts with the Network using Client software, and may therefore be seen as a Client from the perspective of the network

Examples of Users might include are:
A developer, deploying new Smart Contracts;
A person with a mobile device, checking their Account balance
A bank employee, exercising an on-chain derivative contract

Preferably, users possess or control one or more cryptographic private keys, enabling them to digitally sign Transactions.

### Value ID

A Value ID is a unique identifier for a Value (or equivalently a Cell).

Preferably, Value IDs may be used to reference a Value or Cell in Encodings or in network communications.

Preferably, Value IDs are computed using a strong cryptographic hash function applied to the Encoding of the relevant Cell (for a large Value, this could be the Encoding of the top level Cell in a tree of Cells). This provides cryptographic guarantees that it is extremely improbable that two distinct Values will ever be assigned the same Value ID. Hash collisions under such a scheme are highly unlikely, and may be discounted for practical purposes. The example embodiment produces Value IDs using a SHA3-256 hash of the Value Encoding.

### Values

Values are entities that represent some unit of information.

Preferably, some Values are composite, for example data structures that contain multiple component Values.

Preferably, a standard method of representing Values is used to represent all information shared or processed by participants in the Network.

Preferably, Values are represented in a form analogous to data types commonly found in mathematics or computing systems, for example:
Primitive values such as integers or Booleans;
Bit strings;
Values used for naming such as symbols or keywords;
Compound data structures such as lists, maps, vectors and sets;
Data records containing a number of fields;
Blocks and Transactions relevant to the Consensus protocol;
Cryptographic primitives such as hash values or digital signatures

Preferably, Values may be implemented in computer programming languages using Abstract Data Types (ADTs) or using a common base class or interface in an Object-oriented programming language. Such data types can be handled conveniently in a uniform fashion by computer programs.

Preferably, Values are immutable, in the sense that the relevant information contained in a specific value cannot be changed once it is constructed (although implementations may choose to augment their internal representation of Values with additional metadata that is not considered part of the information represented by the value, such as a cached Value ID).

### Vector-Based Prefix Computation

The Consensus algorithm compares sequential sets of data. It compares two or more Orderings to identify blocks are identical. For example, it computes the longest common prefix of two sequences, such as Orderings:
[A, B, C, D, F, G]
[A, B, C, G, D]

The common prefix is [A, B, C] with prefix length 3.

Previous algorithms have unacceptable performance with long Orderings, operating in O(n) time, where n is the length of the shorter chain. They may need to process millions of Blocks with unacceptable latency and unaffordable computational costs. The Protocol combines Merkle Trees, trees with embedded cryptographic hashes, with Radix Trees to compute common prefix lengths. Efficient prefix computation is completed in O(log n) time. It achieves this by:
Storing blocks in Orderings as “Vectors”, where a Vector is a Smart Data Structure that contains an arbitrary sequence of Values;
Implementing a Vector as a radix tree, where each tree node has a constrained number of child nodes, preferably a maximum 16;
Embedding the cryptographic hash of each child node in the parent node. The hashes serve as Smart References;
Examining hashes in Vectors to find the first pair of nodes with different hashes to determine a common prefix. Skipping identical nodes in large vectors improves computational efficiency;

Recursive descent is performed when two corresponding child branches have different hashes, which determines the position where the first difference in element values occurs.

### Example Use of the Invention.

Examples of the invention are open, publicly accessible, decentralised networks designed to support digital assets such as Non-Fungible Tokens (NFTs) and central bank digital currencies (CBDCs). They support flexible, Turing-complete Smart Contracts that may be used to automate trading and settlement of transactions involving such digital assets. The networks is fully decentralised, in the sense that any participant is permitted to operate a Peer server in the network. They use strong cryptographic techniques, such as digital signatures. A system of economic stakes is placed to regulate Peer behaviour, ensuring that the network as a whole is operated in a secure, verifiable, trustworthy manner.

Examples feature a native cryptocurrency (the “native coin”) used within the protocol. They are augmented by a system of Memory Accounting to create economic incentives for efficient use of on-chain memory and Storage. It also features an advanced Virtual Machine for Trusted Code Execution, including features found in modern functional programming languages and an on-chain compiler (beyond the capabilities of most DLT systems). New types of digital assets can be easily implemented and/or managed using this Smart Contract facility.

Examples are designed to support access by Users who submit transactions as Clients of the Network, for example to trade digital assets or execute code for Smart Contracts. Other facilities include client software libraries (available in different programming languages) that are provided to make it easy to implement Client software. Users are expected to use digital signatures to ensure the authenticity of their transactions and the security of their digital assets, facilitated by a system of Accounts that may be controlled by different Users.

To achieve high transaction throughput and low latency, examples make use an efficient implementation of the Consensus Protocol described in this invention. They are supported by efficient data structures and Cell Encodings, an efficient Belief Merge Function for Orderings of Blocks, and an optimised Storage system.

### Peer Servers

The Network consists of one or more internet-connected servers [11], with publicly addressable TCP/IP ports that facilitate connection and communications [12, 15] between other Peers [11, 13] and Clients [14].

### Host Runtime

The Peer servers [11] operate using the Java programming language and the Java Virtual Machine (JVM). They can be operated on servers running common operating systems such as Linux and Windows.

### Networking

The networking implementation uses Java NIO to provide asynchronous, event-driven message handling, primarily for performance reasons. Fixed size buffers used within this implementation allow for backpressure to be applied to connected systems that send too many messages, and mitigates against Denial of Service attacks.

### Peer Protocol

Peers communicate using a standardised protocol termed the Peer Protocol

The Protocol involves sending Messages as a sequence of bytes starting with a message identifier and followed by the encoding of one or more Data Values in a manner defined by the message type. The most important message types implemented include:
CHALLENGE—issue a cryptographic challenge to the participant at the other end of the connection, to prove ownership of one or more private keys
RESPONSE—respond to a challenge with a digital signature proving ownership of a private key
DATA—communicate a data value (as a Cell encoding)
COMMAND—a control instruction to a Peer used for Peer administration
MISSING DATA—a request to provide some Cell value corresponding to a given Value ID, typically used by a Peer or Client to obtain Values that they do not currently hold in their local memory or storage
QUERY—a request to perform a computation on the current Consensus State, but without actually executing as a transaction. Queries cannot modify the State
TRANSACT—a request from a Client for the Peer to submit a transaction for inclusion in Consensus. If successful (including verification of any relevant digital signatures), the Transaction may result in updates to the State
RESULT—communication of the result of some previously sent message
BELIEF—communication of a Peer's Belief data structure, necessary for Peers to converge to Consensus according to the convergent Proof of Stake algorithm described in the Present invention.

Messages are limited to a maximum length of 8191 bytes, which is usually sufficient for small message encodings (e.g. TRANSACT) but insufficient for large Values (such as a whole BELIEF). In effect, only the root Cell(s) of a message are likely to be included, and some child Cells may be excluded. To manage this:
Peers are normally expected to pre-send child Cells using the DATA message to ensure that the recipient is in possession of all relevant Cells when the top-level message arrives. However, Peers should normally only transmit such Cells if they represent Novelty, i.e. have not previously been communicated by the Peer.
If a Peer receives a message but does not have one or more child Cells, it may request the missing child Cells using the MISSING DATA message. If the MISSING DATA request(s) do not result in obtaining the required Cells, the Peer is entitled to ignore the Message.

### Consensus and Belief Merge Process

Utilising the Peer Protocol, Peers execute the Consensus Protocol which primarily consists of the Belief Merge Process [FIG. 2]

### Storage

The Peer server makes use of a custom key/value database to provide the persistent storage required for Peer operation, and to allow for Peer server restarts. The storage implementation uses memory-mapped IO for performance. From the perspective of the Peer server, the storage subsystem enables the Peer to store the encoding of any Cell with a key equal to SHA3-256 hash of the encoding (the Value ID), and to lookup data according to the same value ID.

### Information Model

The embodiment defines a standard information model suitable for use by Peers and Clients, as well as enabling efficient serialisation, storage and communication of information values.

### Value Types

All Values created and transferred within the embodiment are implemented as immutable values in the host runtime environment (the JVM), using a common base class “ACell” which corresponds to an arbitrary Cell.

Most Cells are also Values, although some are used as component parts of larger Values and are not considered valid as Values in their own right.

The main types available in the embodiment are:
Primitives
   Byte—an 8-bit byte, considered as an integer in the range 0 . . . 255
   Double—a 64-bt IEEE double precision floating point value
   Long—a 64-bit signed integer
   Character—a 16-bit UTF16 Character
   Boolean—two possible values “true” and “false”
   Nil—the singleton value “nil”
   Address—A numbered identifier for an account e.g. “#123”
   Symbol—A named identifier e.g. “x”, used in Code
   Keyword—A named value e.g. “.foo” typically used as map keys
String-like objects (arbitrary length)
   Strings—sequence of UTF16 Characters
   Blobs—sequence of 8-bit Bytes
Data Structures
   List—a list of values e.g. “(do 2 3)” generally used to express Code
   Vector—a sequence of values e.g. “[1 2 3]”
   Map—a mapping of keys to values e.g. “{:foo 1, :bar 2}”
   Set—a set of unique values e.g. “#{1 2 3}”
   Record—map-like objects with predefined fields and value types, most commonly used to represent specialised data structures in the embodiment e.g. an Account Record
Code objects
   Syntax—an object used to represent code with optional metadata
   Function—an invokable function that can be executed
   Op—an instruction compiled for the Virtual Machine
Consensus Objects
   State—a complete State
   Block—a block of Transactions
   Transaction—a single instruction to the Network
   Order—a complete Ordering of Blocks
   Belief—the Peer Belief data structure
   SignedData—A digital signature applied any other value

Cells implement some standard functionality to facilitate their use in the Embodiment, including:
The ability to get an Encoding or Value ID for the Cell;
The ability to examine child Cells (if any);
Functionality to validate the correctness of the Cell;
The ability to produce a Smart Reference for the Cell.

All Values that require multiple Cells for their representation are implemented as persistent immutable data structures supporting structural sharing, allowing for efficient updates (avoiding copy-on-write requirements).

### Encoding

Cells are encoded as a sequence of bytes.

The first byte in the sequence is always a “Tag” byte that specifies the type of Cell that the Encoding represents. The remainder of the Encoding is a serialised representation of the information content of the Cell.

The Encoding makes use of typical techniques well-known in the industry to minimise the size of encodings, e.g.
Use of variable length integer encodings where small integers are encoded in less bytes than larger values
Use of bit-fields to indicate the presence/absence of optional values
Deliberately choosing short encodings for common values (e.g. the since byte 0x00 as an encoding for “nil”

### Value IDs

Cells are identified by a Value ID, defined to be equal to the SHA3-256 hash of the encoding, which can be represented as a sequence of 32 bytes (256 bits).

### State

The State managed by the Consensus algorithm is implemented as a single immutable data structure, containing the following information:
An ordered index of Account Addresses to Account Records;
An ordered index of Peer Addresses to Peer Records;
An ordered index of scheduled future transactions;
A small set of global values.

The use of ordered indexes is important to allow efficient lookup of values in the associated data structures, which is implemented in O(log n) time where n is the size of the index.

### Account Records

The State includes Account Records within an index. Each Account may be either or both of the following:
A User Account that is controlled by an external User of the network (protected by a digital signature);
An Actor Account that executes code autonomously according to the rules of the State Transition Function, which may be used to implement Smart Contracts.

An Account may include any of the following information:
A sequence number indicating the total number of transactions processed so far for the Account, which is used to prevent transaction replay attacks;
A balance of the Native Coin;
A balance of memory allowance, used for Memory Accounting;
A map of Symbol to Values, representing the Environment of definitions stored in the Account, typically for programmatic use;
A map of Symbols to metadata, representing optional metadata that may be provided for any of the Symbols defined in the Environment;
A map of holdings, which is provided as convenient storage for additional values assigned by other Accounts, typically used to track balances of user defined tokens or digital assets for this Account;
A controller field, which may be used to grant control over this Account to another Account;
A public key field, which is used to store the Ed25519 public key for a User Account.

Accounts are indexed with an Address, which is a small integer value indicating the position of the Account in the Account index. Addresses are issued sequentially, starting from #0,whenever a new Account is added to the State.

Accounts are central to the security model of the system. In most circumstances, Accounts are read-only from the perspective of most network participants, and can only be updated using a transaction signed by the correct Ed25519 private key. A few carefully controlled exceptions exist to this rule (e.g. you can give native coins to user account without the Account's permission, or you can invoke Smart Contract code in an Actor where the Actor has already made such code callable, in which case the Smart Contact code may update the Account for the Actor under well-defined rules.

### Peer Records

The State includes an index of Peer Records, indexed by the Peer's public key.

Each Peer Record contains:
The Peer Stake (in Native Coins) placed by the Peer as security for its own performance
Any Delegated Stake (in Native Coins) placed by other accounts on this Peer

The total stake on a Peer is used to calculate the voting weight of the Peer in the execution of the Consensus Protocol.

### Reward Pools

Native Coins used for Peer rewards are also stored in the State, and holders of Stake are entitled to claim a share of these accumulated rewards.

Mechanisms are included in the VM to ensure that Stakers cannot claim more rewards than they are due, and that the claimable rewards are defined in proportion to the Peer Stake. There is an incentive for Delegated Stakers to stake on Peers that have a higher Peer Stake, and thus might be deemed more “trustworthy”.

### Native Coin

Each Account in the State is defined to have an amount of a virtual currency which serves as the Native Coin of the network (i.e. is implemented as part of the protocol). The native coin is transferable between Accounts, but cannot be created or destroyed (this is a choice made by the embodiment). The total amount of the Native Coin in the State is defined to be a fixed number of 1,000,000,000,000,000,000 units.

The native coin is useful for:
Placing economic Stake on peers;
Purchasing memory allowances for additional on-chain storage;
Paying small fees associated with executing each transaction by a User Account;
Use as a method of payment for on-chain smart contracts and services;
Converting to stable coin, fiat currencies or crypto currencies.

### Memory Allowance

In addition to the native coin, the State includes a second virtual currency for memory, termed as a memory allowance, which is used for Memory Accounting.

Memory allowance is used primarily for purchasing additional on-chain memory capacity (measured in bytes) during transaction execution as detailed below. It is also transferable and usable as a second virtual currency.

### Virtual Machine

The embodiment implements a Virtual Machine (VM) for the execution of Ops and other runtime functions as part of the State Transition Function.

### Fundamental Ops

The Virtual Machine executes Values known as “Ops”, which are the low-level “bytecode” of the VM used as an embodiment for Trusted Code Execution. The Ops provided are broadly equivalent to the fundamental operations available in a typical implementation of the Lambda Calculus, a functional programming paradigm most commonly associated with the computer language Lisp.

These Ops include:
Constant—load a constant Value in the VM's result register
Invoke—invoke either a runtime function or a user defined function
Do—execute a sequence of child Ops
Cond—conditionally execute operations, in a manner similar to the common programming language construct IF ( . . . ) THEN . . . ELSE IF (THEN) . . . ELSE . . . .
Lookup—look up a value defined by a Symbol in the current execution Context
Def—define a value named by a Symbol in the current execution Context
Lambda—create an instance of a Function (or Closure) as generally used in functional programming languages
Let—bind one or more Symbols to values in the local lexical context
Query—execute an Op, but ignore all state changes
Loop—create an execute code in a loop, where recursion can be controlled by various runtime functions
Special—compute and return various special values relating to the current execution context, such as the native coin balance of the current Account

Ops are represented as a Value in the form of a tree data structure which may optionally contain child Ops. In this sense, Ops can be considered structurally similar to an “Abstract Syntax Tree” commonly used in programming language implementations.

### Runtime Functions

In addition to the Ops executed by the VM, the VM provides a set of Core runtime functions that are built-in to the system. These are generally used to provide user code with the ability to access programmatic capabilities of the VM. The embodiment uses runtime functions that include, but not limited to:
Common numerical operations (addition, subtraction, square roots etc.)
Functions to manipulate and query data structures (e.g. constructing vectors)
Control flow constructs (at a higher level than e.g. Cond)
Functions to support the creation of macros
Functions to support operations relevant to the running of the network, e.g. placing a Stake on one or more Peers
Functions to transfer and manage the native coins on the network
Functions to transfer and manage the memory allowance of an Account
Functions to facilitate calling and interacting with Actors and Smart Contracts
Functions to manage the security of an Account, e.g. rotating the Ed25519 public key

### Expansion and Compilation

The VM implements an on-chain compiler to convert code (expressed as Lisp forms) into a tree of compiled Ops ready for execution. For example the code “(if true 2 3)” would be translated to a the tree of Ops “(Cond (Constant true) (Constant 2) (Constant 3))”

The compiler includes Expander functionality that transforms code forms prior to compilation, similar to most Lisp-based languages. This allows users to define custom macros to extend the language, while still compiling to the same standard set of basic Ops. The embodiment uses “Expansion Passing Style” of macro expanders (Dybvig, Friedman, Haynes 1988).

The process for executing code provided as a Lisp form is:
Expand the form using the default Expander
Compile the form using the on-chain compiler
Execute the resulting Op (which may be the root of a tree of Ops)

Users may also choose to compile code off-chain, and submit an Op directly for execution. This provides some benefits in terms of lower transaction costs and improved performance, so is encouraged if Users do not need to make use of on-chain compilation.

### User Code

User code may be deployed on the VM (as part of the State) that uses the above capabilities to implement custom functionality. Since the capabilities above are Turing-complete, arbitrary user functions can be implemented. For convenience, some user code in the form of utility functions and tools may be automatically deployed to the VM as part of network initialisation.

User code may be specified either as a tree of Ops ready for direct execution on the VM, or alternatively as a Lisp form that is expanded and compiled prior to execution.

User code may be stored in the Environment of a User's Account, or alternatively included directly in a submitted query or transaction.

### Transaction Cost Accounting

The embodiment implements a system of Transaction fees [FIG. 8] to incentivise efficient use of Network resources.

If at any time the transaction fee exceeds the allowed maximum cost, the transaction is aborted with a Juice Error, and the User receives no refund.

### Memory Accounting

At the end of each transaction, the VM examines the memory size of the State to see if this has changed.

The VM calculates Cell Memory Size as:

64+[Memory Size of encoded Cell data]+[sum of Memory Size of any referenced child Cells]

Note: The constant 64 given here is an estimate of the number of bytes of overhead involved in the storage of each Cell.

For efficiency purposes, the Memory Size is cached whenever it is computed for any Cell, and this cached memory size may also be written to Storage alongside cell values.

If a transaction causes an increase in Memory Size, this increase is subtracted from the Account's memory allowance. In the case of a decrease, the memory size difference is returned to the Account's memory allowance as a refund.

If the Account's memory allowance is insufficient to pay for additional memory consumption, an attempt is made to purchase additional memory allowance from a smart contract using the native coin.

If any memory allowance required is successfully used the transaction will be completed normally. Otherwise, the transaction is aborted and any state changes rolled back, with an Error reported to the user.

### Incentive Pools

The embodiment implements a system of incentive Pools to reward Peers for participating in Consensus. Management of these pools is facilitated as part of the VM.

FIG. 7 shows how block rewards are channelled through incentive pools to reward peers for participation and penalize bad peers. A governance account [71] allocates funds [77] of Native Coin to a Long Term Block Reward Pool [72], intended to fund network operations for multiple years.

A gradual release of funds [78] is performed as part of the protocol over time which deposits funds in the Current Block Reward Pool [73]. The rate of transfer is configured to be a proportion (e.g. 20%) of [72] per year.

The current block rewards pool is used to reward [79 and 710] good peers [74 and 75] with a share of the reward pool proportionate to their Stake, paid out over time. The total payout rate is configured to be a proportion (e.g. 10%) of [72] per hour.

Bed Peers [76] are penalised [711] by the removal of some or all of their Stake (“slashing”), which is redistributed to the Current Block Reward Pool.

Because stake removed from bad peers is redistributed quickly via the current block reward pool, good peers have a strong incentive to detect and penalize bad peers since they will share the rewards of doing so.

### Clients

The Network may at any time be joined by Clients, which might include user applications such as web browsers or mobile devices. The Client computers [14] connect to Peers [11] in order to submit and communicate [15] information about Transactions.

Clients correct to one or more Peers by either:
Direct connection to an open TCP/IP port of a chosen Peer, making use of the Peer Protocol
Access via a HTTP REST API using commonly understood web encodings and protocols such as JSON
Direct access to the Peer implementation, for example if Client functionality is also implemented in the Peer's server process or a concurrently running process with appropriate access rights.

Clients are normally required to maintain a secure private key, which is needed so that the Client is able to sign Transactions that are submitted to a Peer. Under normal circumstances, Clients should not reveal the private key itself to any third parties.

### Transactions

Clients normally interact with the Network by submitting transactions (for example using the TRANSACT message of the Peer Protocol). Transactions typically contain:
A sequence number, where 1 is the first transaction and following transactions are numbered sequentially (used to prevent “replay attacks” of identical transactions)
An Address for the account
A digital signature enabling nodes to verify that the transaction was signed by the correct private key for the User Account
A payload, typically in the form of VM Code to be executed.

Peers report the result of transactions back to Clients, generally after the Block that the transaction was included in is confirmed to be in Consensus.

### Client Libraries

To facilitate the development of applications, Client Libraries provide simple APIs for programmatic access to the network capabilities. Capabilities include:
Preparing and submitting transactions to be executed by the Peer network
Querying data on Peers (e.g. requesting the user's current coin balance from the latest Consensus State)
Performing transactions either synchronously (waiting for a result to be confirmed) or asynchronously (submitting a request and checking the result later)
APIs for interacting with specific smart contracts

Client libraries are provided for multiple different programming languages, for example Java, Python, C and JavaScript. The different language versions of the client libraries make it possible to access the capabilities of the decentralised network using APIs, interfaces and idioms that are more familiar to a user of the specific programming language, e.g. in Java a connection to the network is represented by an instance of a Java Class.

1. A system for achieving efficient Consensus comprising:
one or more nodes of various types arranged as arbitrary communication and functional participants in a Network, wherein at least a first node type is termed a Peer,
means for the production of Beliefs by Peers such that each Belief contains data used for forming Consensus;
a Belief Merge Function which combines one or more Beliefs;
wherein the Peers are arranged to maintain the Consensus of the network according to a Consensus Protocol including the application of the Belief Merge Function to Beliefs;
wherein the Belief Merge Function is defined such that the Network exhibits the property of Convergence to a single Consensus.

2. The system according to claim 1, wherein at least a second node type is termed a Client; and
wherein the Clients are arranged to submit new Transactions that may affect the Consensus and query information resulting from the Consensus of the Network.

3. The system according to claim 1, wherein the Belief Merge Function is defined using a computation that is idempotent, associative and commutative, such that the system is able to operate as a Conflict-free Replicated Data Type.

4. The system according to claim 1, further comprising:
a specific type of information units, known as Blocks;
full or partial Orderings of the specific type information units, Blocks, comprising Values and Cells, included as a constituent part of a Belief;
a State Transition Function capable of computing an updated State given some Ordering;
one or more Initial States;
wherein a Consensus State may be computed by repeated application of the State Transition Function to an Initial State and information unit(s) that may be included in the Ordering.

5. The system according to claim 4, further comprising:
collections of zero or more information units known as Transactions which are included as constituent parts of each Block;
optional additional information supplied by the Peer, such as a timestamp or digital signatures;
wherein the Blocks and their constituent Transactions and any additional information are arranged to be included as part of the Ordering.

6. The system according to claim 4,
wherein the information units in an Ordering are defined not to contain references to one or more previous information units, such that it is possible to re-order the Blocks in the Consensus process.

7. The system according to claim 6, further comprising:
means for Computation of Consensus Orderings;
wherein the means for Computation of Consensus Ordering computes a Consensus Ordering as part of the Belief Merge Function.

8. The system according to claim 7, further comprising:
means for assigning a Stake to Peers;
a procedure for Stake Weighted Ordering Merge included as part of the Computation of Consensus Ordering;
wherein the Stake Weighted Ordering Merge is utilized to resolve conflicts between Orderings proposed by different Peers.

9. The system according to claim 7 further comprising:
means for Common Prefix Computation;
wherein the computation of a Common Prefix between Orderings is utilized to reduce the computational costs for Consensus.

10. The system according to claim 1, further comprising:
means for Novelty detection;
wherein nodes observing Novelty may communicate Novelty to other nodes;
wherein nodes may optionally omit communication of information that is not Novelty, in order to save network resources and processing costs.

11. The system according to claim 1 further comprising:
means for representing information Values, which are represented as one or more Cells;
means for producing an Encoding for a Cell, preferably in a form suitable for storage or Network communication;
means for Smart References enabling a reference to a Cell to be included within the information and/or Encoding of another Cell;
means for embedding an Encoding within another Encoding thereby enabling any Value to be completely represented as a graph of Cells connected by Smart References.

12. The system according to claim 11 further comprising:
means for producing a Value ID for a Cell, such as a cryptographic hash function applied to the Encoding;
wherein the Value ID can be used as a unique reference for the information unit.

13. The system according to claim 1, further comprising:
a Convergent Storage for information values;
wherein only the information units currently in active use are required to be in the working memory of a node, and other information units can be persisted to permanent storage and/or deleted if not required for further processing, i.e., garbage collected;
wherein the addition of new information to Storage has the Convergence property, such that data inconsistencies may be avoided.

14. The system according to claim 1 further comprising:
means for computing the Memory Size of a Cell or other information Value;
means for Memory Accounting;
wherein the Memory Accounting is used to assign Incentives to participants on the network, such as to conserve memory, storage and/or communication bandwidth.

15. The system according to claim 14 further comprising:
means of caching computed Memory Sizes for each Cell or information unit either in working memory and/or Storage;
wherein cached Memory Sizes are used to reduce the computational complexity of computing the memory size for large data structures, such as only needing to compute the Memory Size for Novelty.

16. The system according to claim 4 further comprising:
means for Trusted Code Execution arranged to be part of the State Transition Function;
wherein the Trusted Code Execution can be utilized to implement Smart Contracts or other programmable functionality that may affect the Consensus State.

17. The system according to claim 13 further comprising:
one or more Monotonic Headers, which associate header information with information Values and/or Cells;
wherein the Monotonic Header also provides the property of Convergence, such that is can be relied upon for caching, performance optimization and tagging the status of Cells.

18. A computer-implemented method for achieving efficient Consensus comprising:
arranging one or more nodes of various types as arbitrary communication and functional participants in a Network, wherein at least a first node type is termed a Peer,
generating Beliefs by Peers such that each Belief contains data used for forming Consensus;
combining one or more Beliefs into a Belief Merge Function;
wherein the Peers are arranged to maintain the Consensus of the network according to a Consensus Protocol including the application of the Belief Merge Function to Beliefs;
wherein the Belief Merge Function is defined such that the Network exhibits the property of Convergence to a single Consensus.

19. The method according to claim 18, wherein at least a second node type is termed a Client; and
arranging the Clients to submit new Transactions that may affect the Consensus and query information resulting from the Consensus of the Network.

20. The method according to claim 18, wherein the Belief Merge Function is defined using a computation that is idempotent, associative and commutative, such that the system is able to operate as a Conflict-free Replicated Data Type.

21. The method according to claim 18, further comprising:
a specific type of information units, known as Blocks;
full or partial Orderings of the specific type information units, Blocks, comprising Values and Cells, included as a constituent part of a Belief;
a State Transition Function capable of computing an updated State given some Ordering;
one or more Initial States;
wherein a Consensus State may be computed by repeated application of the State Transition Function to an Initial State and information unit(s) that may be included in the Ordering.

22. The method according to claim 21, further comprising:
collections of zero or more information units known as Transactions which are included as constituent parts of each Block;
optional additional information supplied by the Peer, such as a timestamp or digital signatures;
wherein the Blocks and their constituent Transactions and any additional information are arranged to be included as part of the Ordering.

23. The method according to claim 21,
wherein the information units in an Ordering are defined not to contain references to one or more previous information units, such that it is possible to re-order the Blocks in the Consensus process.

24. The method according to claim 23, further comprising:
computing Consensus Orderings;
wherein the Consensus Ordering is computed as part of the Belief Merge Function.

25. The method according to claim 24, further comprising:
assigning a Stake to Peers;
a procedure for Stake Weighted Ordering Merge included as part of the Computation of Consensus Ordering;
wherein the Stake Weighted Ordering Merge is utilized to resolve conflicts between Orderings proposed by different Peers.

26. The method according to claim 24, further comprising:
computing Common Prefix;
wherein the computation of a Common Prefix between Orderings is utilized to reduce the computational costs for Consensus.

27. The method according to claim 18, further comprising:
detecting Novelty;
wherein nodes observing Novelty may communicate Novelty to other nodes;
wherein nodes may optionally omit communication of information that is not Novelty, in order to save network resources and processing costs.

28. The method according to claim 18 further comprising:
representing information Values, which are represented as one or more Cells;
producing an Encoding for a Cell, preferably in a form suitable for storage or Network communication;
enabling Smart References a reference to a Cell to be included within the information and/or Encoding of another Cell;
embedding an Encoding within another Encoding thereby enabling any Value to be completely represented as a graph of Cells connected by Smart References.

29. The method according to claim 28 further comprising:
producing a Value ID for a Cell, such as a cryptographic hash function applied to the Encoding;
wherein the Value ID can be used as a unique reference for the information unit.

30. The method according to claim 28, further comprising:
a Convergent Storage for information values;
wherein only the information units currently in active use are required to be in the working memory of a node, and other information units can be persisted to permanent storage and/or deleted if not required for further processing, i.e., garbage collected;
wherein the addition of new information to Storage has the Convergence property, such that data inconsistencies may be avoided.

31. The method according to claim 18, further comprising:
computing the Memory Size of a Cell or other information Value;
accounting Memory;
wherein the Memory Accounting is used to assign Incentives to participants on the network, such as to conserve memory, storage and/or communication bandwidth.

32. The method according to claim 31, further comprising:
caching computed Memory Sizes for each Cell or information unit either in working memory and/or Storage;
wherein cached Memory Sizes are used to reduce the computational complexity of computing the memory size for large data structures, such as only needing to compute the Memory Size for Novelty.

33. The method according to claim 32, further comprising:
arranging Trusted Code Execution to be part of the State Transition Function;
wherein the Trusted Code Execution can be utilized to implement Smart Contracts or other programmable functionality that may affect the Consensus State.

34. The method according to claim 30, further comprising:
one or more Monotonic Headers, which associate header information with information Values and/or Cells;
wherein the Monotonic Header also provides the property of Convergence, such that is can be relied upon for caching, performance optimization and tagging the status of Cells.
